(19) United States
(12) Patent Application Publication
(10) Pub. No.: US 2013/0120331 A1
(43) Pub. Date: May 16, 2013

(54) DISPLAY DEVICE

(71) Applicants: Kaoru Yamamoto, Osaka-shi (JP); Yasuhiro Sugita, Osaka-shi (JP); Kohei Tanaka, Osaka-shi (JP)

(72) Inventors: Kaoru Yamamoto, Osaka-shi (JP); Yasuhiro Sugita, Osaka-shi (JP); Kohei Tanaka, Osaka-shi (JP)

(73) Assignee: Sharp Kabushiki Kaisha, Osaka-shi, Osaka (JP)

(21) Appl. No.: 13/810,773

(22) PCT Filed: Jul. 26, 2011
(86) PCT No.: PCT/JP2011/066902

§ 371 Date: Jan. 17, 2013

(30) Foreign Application Priority Data
Jul. 27, 2010 (JP) 2010-168684

(51) Int. Cl. G06F 3/03

(52) U.S. Cl. CPC G06F 3/0304
USPC 345/207

(57) ABSTRACT

A sensor pixel circuit (9) includes: a light receiving element (PD); a first node Vsig that retains charges corresponding to an amount of light incident on the light receiving element; and a second node Vint that receives charges from the first node

Vsig and retains the charges. Under control by a driving circuit (7), during one of a detection period while a light source (3) for sensors is in an ON state and a detection period while the light source (3) for sensors is in an OFF state, charges corresponding to an amount of light incident on the light receiving element (PD) during this detection period are accumulated in the first node Vsig. The charges accumulated are transferred from the first node Vsig to the second node Vint. During the other one of the detection period while the light source for sensors is in the ON state and the detection period while the light source for sensors is in the OFF state, charges corresponding to an amount of light incident on the light receiving element (PD) during this detection period are accumulated in the first node Vsig, and the charges accumulated are transferred from the first node Vsig to the second node Vint. By doing so, a value of a difference between the amount of light accumulated while the light source for sensors is in the ON state and the amount of light accumulated while the light source for sensors is in the OFF state is determined in the second node Vint.

### TECHNICAL FIELD

The present invention relates to a display device, and particularly relates to a display device provided with a plurality of optical sensors in a pixel region.

### BACKGROUND ART

Conventionally, relating to a display device, a method of providing an input function such as a touch panel, pen input, or a scanner by providing a plurality of optical sensors in a display panel has been known. In order to apply this method to mobile equipment that is used under various light environments, it is necessary to remove influences of the light environments. A method of removing components dependent on light environments from a signal detected by an optical sensor so as to determine a signal that should be input has been known as well.

Patent Document 1 discloses a configuration in which, in an input/output device provided with light receiving elements corresponding to individual display elements, respectively, a backlight is caused to blink once during one frame period and resetting and readout are carried out line-sequentially with respect to the light receiving elements so that an amount of light during a backlight-on period and an amount of light during a backlight-off period are obtained from every light receiving element during one frame period.

FIG. 53 shows turning-on and turning-off timings with respect to a backlight, and resetting and readout timings with respect to light receiving elements disclosed in JP4072732B. As shown in FIG. 53, the backlight is turned on in a former half of one frame period, and is turned off in a latter half of the same. The light receiving elements are reset line-sequentially during the backlight-on period (indicated by solid line arrows), and thereafter, readout from the light receiving elements is carried out line-sequentially (indicated by broken line arrows). During the backlight-off period also, the resetting and the readout with respect to the light receiving elements are carried out in the same manner.

JP3521187B discloses a solid-state image pickup device having unit light-receiving parts as shown in FIG. 54. The unit light-receiving part shown in FIG. 54 includes one photoelectric conversion portion PD and two charge accumulation portions C1 and C2. To receive both of the reflection light that occurs when light from a light-emitting means is reflected from an object and external light, a first sample gate SG1 is turned on, and charges generated by the photoelectric conversion portion PD are accumulated in the first charge accumulation portion C1. To receive only external light, the second sample gate SG2 is turned on, and charges generated by the photoelectric conversion portion PD are accumulated in the second charge accumulation portion C2. A difference between amounts of charges accumulated in the two charge accumulation portions C1 and C2 is determined, whereby an amount of light that is from the light emitting means and is reflected by the object can be determined.

Generally, in a display device in which a plurality of optical sensors are provided in a display panel, the readout from the optical sensors is carried out line-sequentially. Further, a backlight for mobile equipment is turned on for an entirety of a screen simultaneously, and is turned off simultaneously.

In an input/output device disclosed in JP4072732B, a backlight is blinked once during one frame period, so that resetting and readout are carried out during periods that do not overlap, respectively, during a backlight-on period, and resetting and readout are carried out during periods that do not overlap, respectively, during a backlight-off period as well. Therefore, it is necessary to carry out the readout from light-receiving elements within ¼ frame (e.g., within 1/240 second in the case where the frame rate is 60 frames/second). It is, however, very difficult actually to carry out such high-speed readout.

Besides, there is a difference of ½ frame between the period (B1 shown in FIG. 53) while the light receiving elements detect light during the backlight-on period and the period (B2 shown in FIG. 53) while the light receiving elements detect light during the backlight-off period. Therefore, the followability with respect to motion input fluctuates depending on the direction of input. Further, the input/output device starts the readout immediately after the completion of resetting, and starts the resetting immediately after the completion of readout. Therefore, it is impossible to freely decide the lengths of the backlight-on period and the backlight-off period, and the intervals thereof.

Still further, in a system in which a difference between sensor outputs of the backlight-on period and the backlight-off period is detected as conventionally, the difference cannot be detected if the output is saturated. In order not to saturate the output, it is unavoidably necessary either to cause optical sensors to have lower sensitivity, or to decrease the shutter speed (accumulation period). These attempts, however, are contradictory to the object of realizing a high-precision optical sensor, and it is difficult to find optimal design values.

It is an object of the present invention to provide a display device that solves the above-described problems and has an input function that is not dependent on ambient light environments.

### DISCLOSURE OF INVENTION

To achieve the above-described object, a display device disclosed herein has a configuration that includes: a display panel that includes a plurality of display pixel circuits and a plurality of sensor pixel circuits in a display region; a light source for sensors that is turned on for a predetermined period during one cyclic period; and a driving circuit that supplies a driving signal to the sensor pixel circuits, wherein the sensor pixel circuit includes: a light receiving element; a first node that retains charges corresponding to an amount of light incident on the light receiving element; and a second node that receives charges from the first node and retains the charges, wherein under control by the driving circuit, during one of a detection period while the light source for sensors is in an ON state and a detection period while the light source for sensors is in an OFF state, charges corresponding to an amount of light incident on the light receiving element during this detection period are accumulated in the first node; the charges accumulated in the first node are transferred from the first node to the second node; during the other one of the detection period while the light source for sensors is in the ON state and the detection period while the light source for sensors is in the OFF state, charges corresponding to an amount of light incident on the light receiving element during this detection period are accumulated in the first node; and the charges accumulated in the first node are transferred from the first node to the second node, whereby a value of a difference between the amount of light accumulated during the detection period while the light source for sensors is in the ON state and the amount of light accumulated during the detection period while the light source for sensors is in the OFF state is determined in the second node.

According to the present invention, a display device can be provided that has an input function that is not influenced by ambient light environments.

### BRIEF DESCRIPTION OF DRAWINGS

FIG. 1 is a block diagram showing a configuration of a display device according to an embodiment of the present invention.

FIG. 2 shows an arrangement of sensor pixel circuits in a display panel included in the display device shown in FIG. 1.

FIG. 3 shows timings for turning on and off a backlight and timings for resetting and readout with respect to sensor pixel circuits when one cycle of driving is carried out in the display device according to FIG. 1.

FIG. 4 shows a schematic configuration of a sensor pixel circuit included in the display device shown in FIG. 1.

FIG. 5 is a waveform diagram of driving signals for driving the sensor pixel circuit shown in FIG. 4 at the timings shown in FIG. 3.

FIG. 6A shows an operation of the sensor pixel circuit in the case where the sensor pixel circuit is driven by the signals shown in FIG. 5.

FIG. 6B shows an operation of the sensor pixel circuit in the case where the sensor pixel circuit is driven by the signals shown in FIG. 5.

FIG. 6C shows an operation of the sensor pixel circuit in the case where the sensor pixel circuit is driven by the signals shown in FIG. 5.

FIG. 7 is a signal waveform diagram of the sensor pixel circuit in the case where the sensor pixel circuit is driven by the signals shown in FIG. 5.

FIG. 8 is a waveform diagram of signals applied to a sensor pixel circuit in Embodiment 2.

FIG. 9A shows an operation of the sensor pixel circuit in the case where the sensor pixel circuit is driven by the signals shown in FIG. 8, in Embodiment 2.

FIG. 9B shows an operation of the sensor pixel circuit in the case where the sensor pixel circuit is driven by the signals shown in FIG. 8, in Embodiment 2.

FIG. 9C shows an operation of the sensor pixel circuit in the case where the sensor pixel circuit is driven by the signals shown in FIG. 8, in Embodiment 2.

FIG. 9D shows an operation of the sensor pixel circuit in the case where the sensor pixel circuit is driven by the signals shown in FIG. 8, in Embodiment 2.

FIG. 10 is a circuit diagram showing a specific configuration of a sensor pixel circuit according to Embodiment 3.

FIG. 11 is a circuit diagram showing an operation of the sensor pixel circuit shown in FIG. 10.

FIG. 12 is a circuit diagram showing a specific configuration of a sensor pixel circuit according to Embodiment 4.

FIG. 13 is a waveform diagram of signals applied to the sensor pixel circuit shown in FIG. 12.

FIG. 14 is a circuit diagram showing a specific configuration of a sensor pixel circuit 9 according to Embodiment 5.

FIG. 15 is a waveform diagram of signals applied to a sensor pixel circuit 9d shown in FIG. 14.

FIG. 16 is a circuit diagram showing a specific configuration of a sensor pixel circuit according to Embodiment 6.

FIG. 17 is a circuit diagram showing a configuration of a modification example of the sensor pixel circuit according to Embodiment 1.

FIG. 18 is a circuit diagram showing a configuration of a modification example of the sensor pixel circuit according to Embodiment 1.

FIG. 19 is a circuit diagram showing a configuration of a modification example of the sensor pixel circuit according to Embodiment 1.

FIG. 20 is a circuit diagram showing a configuration of a modification example of the sensor pixel circuit according to Embodiment 1.

FIG. 21 is a circuit diagram showing a configuration of a modification example of the sensor pixel circuit according to Embodiment 1.

FIG. 22 is a circuit diagram showing a configuration of a modification example of the sensor pixel circuit according to Embodiment 1.

FIG. 23 is a circuit diagram showing a configuration of a modification example of the sensor pixel circuit according to Embodiment 1.

FIG. 24 is a circuit diagram showing a configuration of a modification example of the sensor pixel circuit according to Embodiment 1.

FIG. 25 is a circuit diagram showing a configuration of a modification example of the sensor pixel circuit according to Embodiment 1.

FIG. 26 is a circuit diagram showing a configuration of a modification example of the sensor pixel circuit according to Embodiment 1.

FIG. 27 is a circuit diagram showing a configuration of a modification example of the sensor pixel circuit according to Embodiment 1.

FIG. 28 is a circuit diagram showing a configuration of a modification example of the sensor pixel circuit according to Embodiment 1.

FIG. 29 is a circuit diagram showing a configuration of a modification example of the sensor pixel circuit according to Embodiment 1.

FIG. 30 is a circuit diagram showing a configuration of a modification example of the sensor pixel circuit according to Embodiment 1.

FIG. 31 is a circuit diagram showing a configuration of a modification example of the sensor pixel circuit according to Embodiment 1.

FIG. 32 is a circuit diagram showing a configuration of a modification example of the sensor pixel circuit according to Embodiment 1.

FIG. 33 is a circuit diagram showing a configuration of a modification example of the sensor pixel circuit according to Embodiment 3.

FIG. 34 is a circuit diagram showing a configuration of a modification example of the sensor pixel circuit according to Embodiment 3.

FIG. 35 is a circuit diagram showing a configuration of a modification example of the sensor pixel circuit according to Embodiment 3.

FIG. 36 is a circuit diagram showing a configuration of a modification example of the sensor pixel circuit according to Embodiment 3.

FIG. 37 is a circuit diagram showing a configuration of a modification example of the sensor pixel circuit according to Embodiment 3.

FIG. 38 is a circuit diagram showing a configuration of a modification example of the sensor pixel circuit according to Embodiment 3.

FIG. 39 is a circuit diagram showing a configuration of a modification example of the sensor pixel circuit according to Embodiment 4.

FIG. 40 is a circuit diagram showing a configuration of a modification example of the sensor pixel circuit according to Embodiment 4.

FIG. 41 is a circuit diagram showing a configuration of a modification example of the sensor pixel circuit according to Embodiment 4.

FIG. 42 is a circuit diagram showing a configuration of a modification example of the sensor pixel circuit according to Embodiment 4.

FIG. 43 is a circuit diagram showing a configuration of a modification example of the sensor pixel circuit according to Embodiment 4.

FIG. 44 is a circuit diagram showing a configuration of a modification example of the sensor pixel circuit according to Embodiment 4.

FIG. 45 is a circuit diagram showing a configuration of a modification example of the sensor pixel circuit according to Embodiment 5.

FIG. 46 is a circuit diagram showing a configuration of a modification example of the sensor pixel circuit according to Embodiment 5.

FIG. 47 is a circuit diagram showing a configuration of a modification example of the sensor pixel circuit according to Embodiment 5.

FIG. 48 is a circuit diagram showing a configuration of a modification example of the sensor pixel circuit according to Embodiment 5.

FIG. 49 is a circuit diagram showing a configuration of a modification example of the sensor pixel circuit according to Embodiment 5.

FIG. 50 is a circuit diagram showing a configuration of a modification example of the sensor pixel circuit according to Embodiment 5.

FIG. 51 is a circuit diagram showing a configuration of a modification example of the sensor pixel circuit according to Embodiment 5.

FIG. 52 is a circuit diagram showing a configuration of a modification example of the sensor pixel circuit according to Embodiment 5.

FIG. 53 shows timings for turning on and off a backlight and timings for resetting and readout with respect to sensor pixel circuits in a conventional input/output device.

FIG. 54 is a circuit diagram of a unit light receiving part included in a conventional solid-state image pickup device.

### DESCRIPTION OF THE INVENTION

A display device according to one embodiment has a configuration that includes:

a display panel that includes a plurality of display pixel circuits and a plurality of sensor pixel circuits in a display region;

a light source for sensors that is turned on for a predetermined period during one cyclic period; and

a driving circuit that supplies a driving signal to the sensor pixel circuits,

wherein the sensor pixel circuit includes:

a light receiving element;

a first node that retains charges corresponding to an amount of light incident on the light receiving element; and

a second node that receives charges from the first node and retains the charges,

wherein under control by the driving circuit,

during one of a detection period while the light source for sensors is in an ON state and a detection period while the light source for sensors is in an OFF state, charges corresponding to an amount of light incident on the light receiving element during this detection period are accumulated in the first node,

the charges accumulated in the first node are transferred from the first node to the second node,

during the other one of the detection period while the light source for sensors is in the ON state and the detection period while the light source for sensors is in the

OFF state, charges corresponding to an amount of light incident on the light receiving element during this detection period are accumulated in the first node,

and

the charges accumulated in the first node are transferred from the first node to the second node,

whereby a value of a difference between the amount of light accumulated during the detection period while the light source for sensors is in the ON state and the amount of light accumulated during the detection period while the light source for sensors is in the OFF state is determined in the second node.

The above-described display device may have a configuration in which the sensor pixel circuit includes:

a first switching element that controls conduction/non-conduction between the light receiving element and the first node;

a first capacitor connected to the second node;

a second capacitor provided between the first switching element and the second node;

a second switching element that controls conduction/non-conduction between the second node and a reference voltage supplying line; and

a readout switching element connected to the accumulation node.

Alternatively, the above-described display device may have a configuration in which the sensor pixel circuit includes:

a first switching element that controls conduction/non-conduction between the light receiving element and the first node;

a first capacitor connected to the second node;

a second capacitor provided between the first switching element and the second node;

a second switching element that controls conduction/non-conduction between the second node and a reference voltage supplying line;

a readout switching element connected to the accumulation node; and

an amplifier provided between the light receiving element and the first switching element.

Alternatively, the above-described display device may have a configuration in which the sensor pixel circuit includes:

a first switching element that controls conduction/non-conduction between the light receiving element and the first node;

a first capacitor connected to the second node;

a second capacitor provided between the first switching element and the second node;

a second switching element that controls conduction/non-conduction between the second node and a reference voltage supplying line;

a readout switching element connected to the accumulation node; and

a third switching element that resets the first node.

Alternatively, the above-described display device may have a configuration in which the sensor pixel circuit includes:

a first switching element that controls conduction/non-conduction between the light receiving element and the first node;

a second switching element that controls conduction/non-conduction between the light receiving element and the second node;

a first capacitor connected to the second node;

a third node that receives charges from the first node and retains the same;

a second capacitor provided between the third node and the second node;

a third switching element that resets the third node; and

a readout switching element connected to the accumulation node.

Alternatively, the above-described display device may have a configuration in which the first capacitor is a P-type transistor.

Alternatively, the above-described display device may have a configuration in which the sensor pixel circuit further includes a reference light receiving element that is connected to the light receiving element in series and is shielded from light, and

one of two terminals other than a control terminal of the first switching element is connected to between the light receiving element and the reference light receiving element.

Alternatively, the above-described display device may have a configuration in which the light receiving element is an N-type transistor.

Alternatively, the above-described display device may have a configuration that further includes a selection switching element that is connected to the readout switching element in series and controls conduction/non-conduction between the accumulation node and an output line of the sensor pixel circuit.

A method for driving a display device according to one embodiment of the present invention is a method for driving a display device that includes: a display panel that includes a plurality of display pixel circuits and a plurality of sensor pixel circuits in a display region; a light source for sensors that is turned on for a predetermined period during one cyclic period; and a driving circuit that supplies a driving signal to the sensor pixel circuits, wherein the sensor pixel circuit includes: a light receiving element; a first node that retains charges corresponding to an amount of light incident on the light receiving element; and a second node that receives charges from the first node and retains the charges,

the method comprising the steps of, under control by the driving circuit:

during one of a detection period while the light source for sensors is in an ON state and a detection period while the light source for sensors is in an OFF state, accumulating, in the first node, charges corresponding to an amount of light incident on the light receiving element during this detection period;

transferring the charges accumulated in the first node, from the first node to the second node;

during the other one of the detection period while the light source for sensors is in the ON state and the detection period while the light source for sensors is in the OFF state, accumulating, in the first node, charges corresponding to an amount of light incident on the light receiving element during this detection period,

and

transferring the charges accumulated in the first node, from the first node to the second node,

so that a value of a difference between the amount of light accumulated during the detection period while the light source for sensors is in the ON state and the amount of light accumulated during the detection period while the light source for sensors is in the OFF state is determined in the second node.

### Embodiment

Hereinafter, more specific embodiments of the present invention are explained with reference to the drawings. It should be noted that the following embodiments show exemplary configurations in the case where a display device according to the present invention is embodied as a liquid crystal display device, but the display device according to the present invention is not limited to a liquid crystal display device, and the present invention is applicable to an arbitrary display device in which an active matrix substrate is used. It should be noted that a display device according to the present invention, as having optical sensors, is assumed to be used as a touch-panel-equipped display device that detects an object approaching its screen and carries out an input operation, as a display device for two-way communication having a display function and an image pickup function, etc.

Further, the drawings referred to hereinafter show, in a simplified manner, only principal members illustration of which is needed for explanation of the present invention, among constituent members of an embodiment of the present invention, for convenience of explanation. Therefore, a display device according to the present embodiment may include arbitrary members that are not shown in the drawings that the present specification refers to. Further, the dimensions of the members shown in the drawings do not faithfully reflect actual dimensions of constituent members, dimensional ratios of the constituent members, etc.

### [Overall Configuration of Display Device]

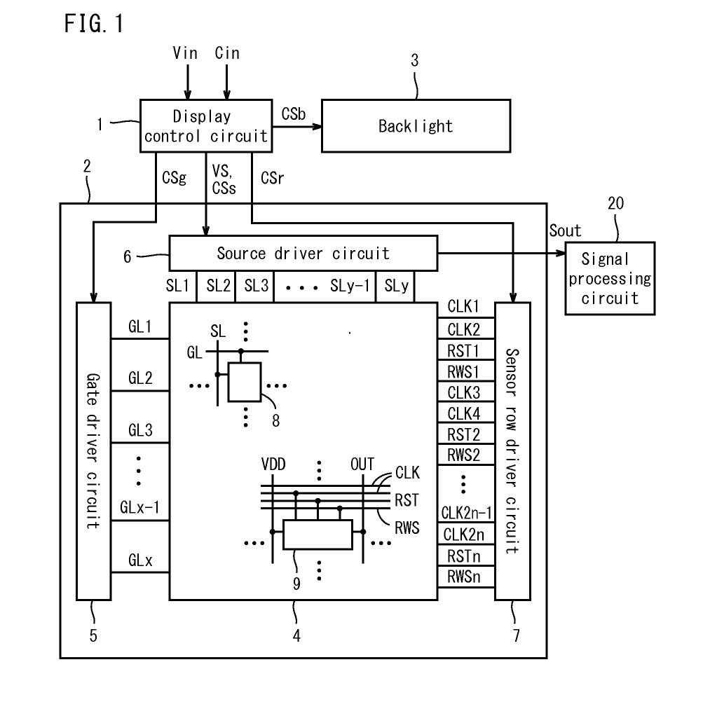

FIG. 1 is a block diagram showing a configuration of a display device according to Embodiment 1 of the present invention. A display device shown in FIG. 1 includes a display control circuit 1, a display panel 2, and a backlight 3. The display panel 2 includes a pixel region 4, a gate driver circuit 5, a source driver circuit 6, and a sensor row driver circuit 7. The pixel region 4 includes a plurality of display pixel circuits 8 and a plurality of sensor pixel circuits 9. This display device has a function of displaying images on the display panel 2 and a function of detecting light incident on the display panel 2. In the following description, x represents an integer of 2 or more, y represents a multiple of 3, and m and n represent even integers, respectively, while the display device has a frame rate of 60 frames per second.

To the display device shown in FIG. 1, a video signal Vin and a timing control signal Cin are supplied from outside. Based on these signals, the display control circuit 1 outputs a video signal VS and control signals CSg, CSs, and CSr to the display panel 2, and outputs a control signal CSb to the backlight 3. The video signal VS may be identical to the video signal Vin, or alternatively, a signal obtained by subjecting the video signal Vin to signal processing.

The backlight 3 is a light source for sensing that is provided separately from a light source for display, and irradiates the display panel 2 with light. More specifically, the backlight 3 is provided on a back side of the display panel 2, and irradiates a back face of the display panel 2 with light. The backlight 3 is turned on when the control signal CSb is at a high level, while it is turned off when the control signal CSb is at a low level. As the backlight 3, an infrared light source can be used, for example.

In the pixel region 4 of the display panel 2, the display pixel circuits 8, which are (x×y) in number, and the sensor pixel circuits 9, which are (n×m) in number, are provided two-dimensionally, respectively. More specifically, x gate lines GL1 to GLx, and y source lines SL1 to Sly are provided in the pixel region 4. The gate lines GL1 to GLx are arranged in parallel with one another, and the source lines SL1 to SLy are arranged in parallel with one another, so as to cross the gate lines GL1 to GLx perpendicularly. The (x×y) display pixel circuits 8 are arranged in the vicinities of intersections of the gate lines GL1 to GLx and the source lines SL1 to SLy. Each display pixel circuit 8 is connected to one gate line GL and one source line SL. The display pixel circuits 8 are classified into those for displaying red, those for displaying green, and those for displaying blue. Every three of the display pixel circuits 8 that belong to these three types, respectively, are aligned in a direction in which the gate lines GL1 to GLx are extended, and constitute one color pixel.

In the pixel region 4, 2n clock lines CLK1 to CLK2n, n reset lines RST1 to RSTn, and n readout lines RWS1 to RWSn are provided in parallel with the gate lines GL1 to GLx. Further, in the pixel region 4, other signal lines and power source lines (not shown) are provided in parallel with the gate lines GL1 to GLx in some cases. When readout from the sensor pixel circuits 9 is carried out, m source lines selected from the source lines SL1 to SLy are used as power source lines VDD1 to VDDm, and m other lines are used as output lines OUT1 to OUTm.

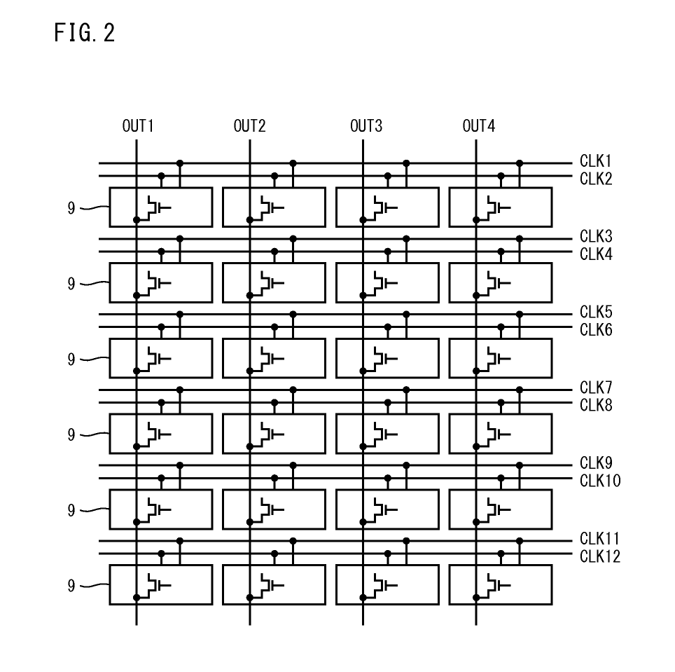

FIG. 2 shows an arrangement of the sensor pixel circuits 9 in the pixel region 4. In FIG. 2, two clock lines CLK and one output line OUT are connected to each of the (n×m) sensor pixel circuits 9.

The gate driver circuit 5 drives the gate lines GL1 to GLx. More specifically, the gate driver circuit 5 sequentially selects the gate lines GL1 to GLx one by one based on the control signal CSg, and applies a high level potential to the selected gate line, while applying a low level potential to the other gate lines. By doing so, y display pixel circuits 8 connected to the selected gate line are selected at once.

The source driver circuit 6 drives the source lines SL1 to SLy. More specifically, based on the control signal CSs, the source driver circuit 6 applies potentials according to the video signal VS to the source lines SL1 to SLy, respectively. Here, the source driver circuit 6 may perform line-sequential driving, or alternatively, dot-sequential driving. The potentials applied to the source lines SL1 to SLy are written in y display pixel circuits 8 selected by the gate driver circuit 5. In this way, by writing potentials corresponding to the video signals VS into all of the display pixel circuits 8, respectively, using the gate driver circuit 5 and the source driver circuit 6, desired images can be displayed on the display panel 2.

The sensor row driver circuit 7 drives the clock lines CLK1 to CLK2n, the reset lines RST1 to RSTn, the readout lines RWS1 to RWSn, and the like. More specifically, based on the control signal CSr, the sensor row driver circuit 7 applies a high level potential and a low level potential to the clock lines CLK1 to CLK2n at predetermined timings (details will be described later). Based on the control signal CSr, the sensor row driver circuit 7 selects one reset line out of the reset lines RST1 to RSTn, and applies a high level potential for resetting to the selected reset lines, while applying a low level potential to the other reset lines. Thus, m sensor pixel circuits 9 connected to the reset lines to which the high level potential is applied are reset at once.

Based on the control signal CSr, the sensor row driver circuit 7 sequentially selects one readout line out of the readout lines RWS1 to RWSn, and applies a high level potential for readout to the selected readout line, while applying a low level potential for readout to the other readout lines. This causes m sensor pixel circuits 9 connected to the selected readout line to become ready to be read out at once. Here, the source driver circuit 6 applies a high level potential to the power source lines VDD1 to VDDm. This causes signals corresponding to amounts of light detected by the respective sensor pixel circuits 9 (hereinafter referred to as sensor signals) to be output from the m sensor pixel circuits 9 ready to be read out to the output lines OUT1 to OUTm. The output lines OUT double as the source lines SL, and the sensor signals output to the output lines OUT are input to the source driver circuit 6.

The source driver circuit 6 amplifies the sensor signal output from the output line OUT, and outputs the amplified signal as a sensor output Sout to the outside of the display panel 2. The sensor output Sout is processed appropriately as required by the signal processing circuit 20 provided outside the display panel 2. In this way, by reading out sensor signals from all the sensor pixel circuits 9 by using the source driver circuit 6 and the sensor row driver circuit 7, light incident on the display panel 2 can be detected.

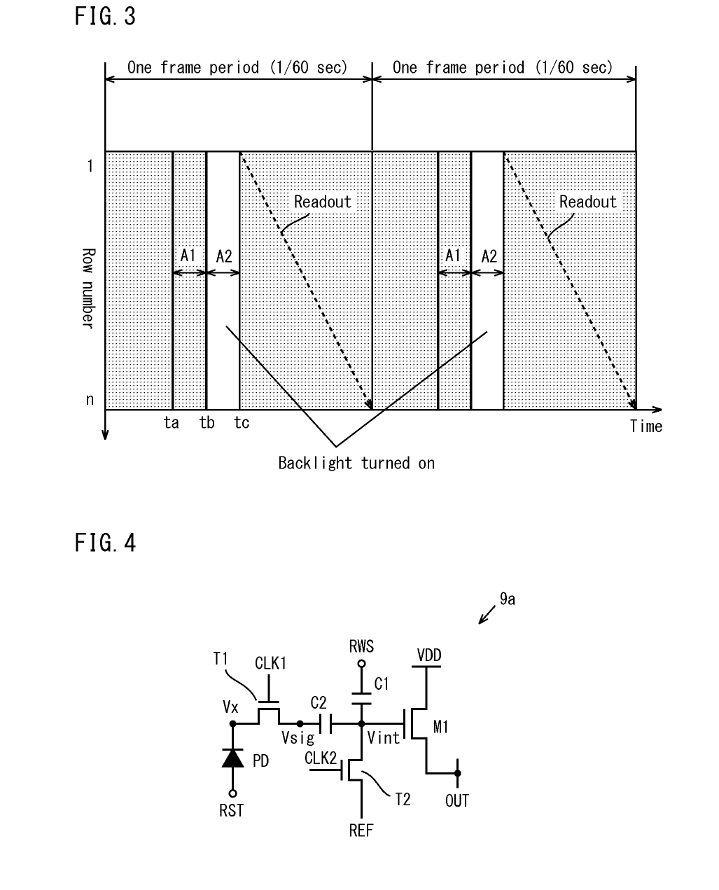

FIG. 3 shows timings of turning on and off the backlight 3 and timings of resetting and readout with respect to the sensor pixel circuits 9. In the example shown in FIG. 3, the backlight 3 is turned on once, for a predetermined period of time, during one frame period, and is turned off during the other period. More specifically, the backlight 3 is turned on at a time tb in one frame period, and is turned off at a time tc.

The sensor pixel circuit 9 detects light incident during a period A1 from the time ta to the time tb (backlight-off period of the backlight 3), and accumulates the light, as will be described later in detail. The sensor pixel circuit 9 at the time tb samples charges accumulated during the period A1, and thereafter detects light incident during a period A2 from the time tb to the time tc (backlight-on period of the backlight 3), and accumulates the light. This allows a difference between the charges accumulated in the period A1 and the charges accumulated in the period A2 to be determined in the sensor pixel circuit 9. The readout from the sensor pixel circuits 9 is performed in parallel, line-sequentially, after the time tc. It should be noted that in

FIG. 3 the readout from the sensor pixel circuits 9 is completed during one frame period, but this may be completed by the time when the resetting is performed with respect to the sensor pixel circuits 9 in the next frame period (by the time ta).

It should be noted that FIG. 3 shows an example in which the readout from the sensor pixel circuits 9 is carried out once during one frame period, but the configuration may be such that the readout from the sensor pixel circuits 9 is carried out twice or more during one frame period.

It should be noted that the number of the sensor pixel circuits 9 provided in the pixel region 4 may be arbitrary. For example, (n×m×2) sensor pixel circuits 9 may be provided in the pixel region 4, or alternatively, the same number (i.e., (x×y/3)) of the sensor pixel circuits 9 as the number of the color sub-pixels may be provided in the pixel region 4. Further alternatively, a smaller number (e.g., one several-th to one several tenths of the color sub-pixels) of the sensor pixel circuits 9, than the number of color sub-pixels, may be provided in the pixel region 4.

In this way, a display device according to an embodiment of the present invention is a display device in which a plurality of photodiodes (light receiving elements) are arranged in the pixel region 4, and the display device includes the display panel 2 and the sensor row driver circuit 7 (driving circuit), wherein the display panel 2 includes a plurality of the display pixel circuits 8 and a plurality of the sensor pixel circuits 9, and the sensor row driver circuit 7 outputs a clock signal CLK (control signal) to the sensor pixel circuits 9.

Hereinafter, several specific examples of the configuration of the sensor pixel circuit 9 and the method for driving the sensor pixel circuit 9 are explained with reference to the drawings, as more specific embodiments of the display device. In the following explanation, signals on signal lines are referred to with the same names as the names of the signal lines, so that the signals can be distinguished (for example, the signal on the clock line CLK1 is referred to as “a clock signal CLK1”).

### Embodiment 1

FIG. 4 is a circuit diagram showing a configuration of a sensor pixel circuit 9a as a specific example of the sensor pixel circuit 9. In FIG. 4, clock lines connected to the sensor pixel circuit 9a are clock lines CLK1 and CLK2. As shown in FIG. 4, the sensor pixel circuit 9a is connected to, not only the clock lines CLK1 and CLK2, but also to a reset line RST, a readout line RWS, a power source line VDD, and an output line OUT. The sensor pixel circuit 9a includes transistors T1, T2, and M1, a photodiode PD, and capacitors C1 and C2. The transistors T1, T2, and M1 are, for example, N-type TFTs (thin film transistors).

In the sensor pixel circuit 9a, the anode of the photodiode PD is connected to the reset line RST, and the cathode thereof is connected to the source of the transistor T1. The gate of the transistor T1a is connected to the clock line CLK1, and the drain thereof is connected to one of electrodes of the capacitor C2. The other electrode of the capacitor C2 is connected to the gate of the transistor M1. The drain of the transistor M1 is connected to the power source line VDD, and the source thereof is connected to the output line OUT. The capacitor C1 is provided between the gate of the transistor M1 and the readout line RWS. The transistor M1 functions as a readout transistor. The gate of the transistor T2 is connected to the clock line CLK2, the drain thereof is connected to the capacitor C1, and the source thereof is connected to a power source line REF that supplies a reference voltage Vref.

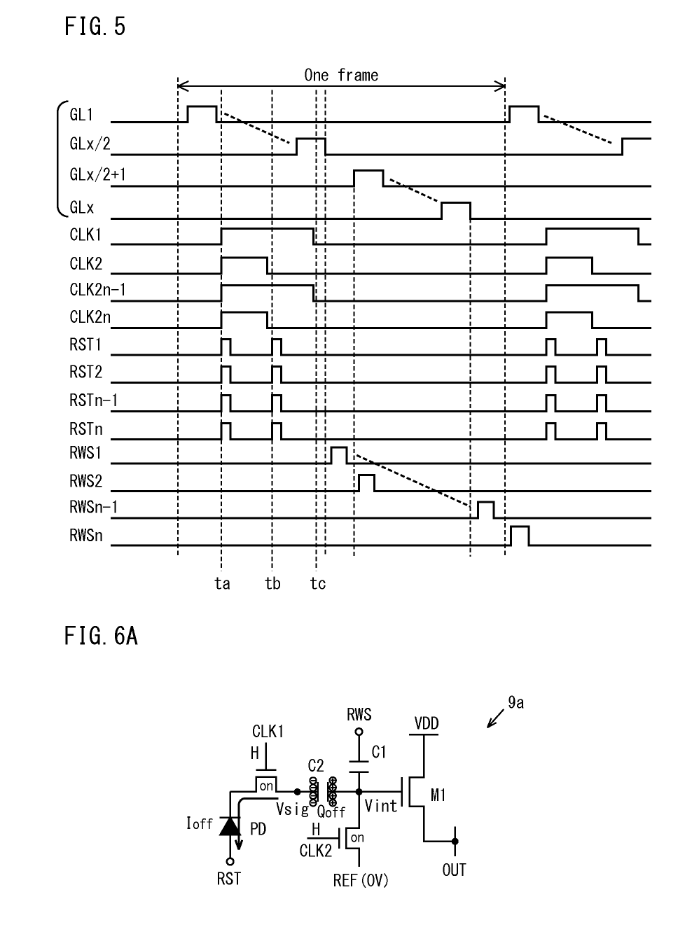

FIG. 5 is a waveform diagram of driving signals for driving the sensor pixel circuits 9a at timings shown in FIG. 3. As shown in FIG. 5, the potentials of the gate lines GL1 to GLx sequentially rise to the high level once each in one frame period, for a predetermined of time each. The potentials of the odd-number-th clock line CLK1 to CLK2n-1 rise to the high level once in one frame period, during the periods A1 to A2 (more specifically, from the time ta to slightly before the time tc). The potentials of the even-number-th clock lines CLK2 to CLK2n rise to the high level once in one frame period, during the period A1 (more specifically, from the time ta to slightly before the time tb). The potentials of the reset lines RST1 to RSTn rise to the high level twice in one frame period, for a predetermined period, at the beginning of the period A1 and at the beginning of the period A2, respectively. The potentials of the readout lines RWS1 to RWSn sequentially rise to the high level after the time tc, for a predetermined period each.

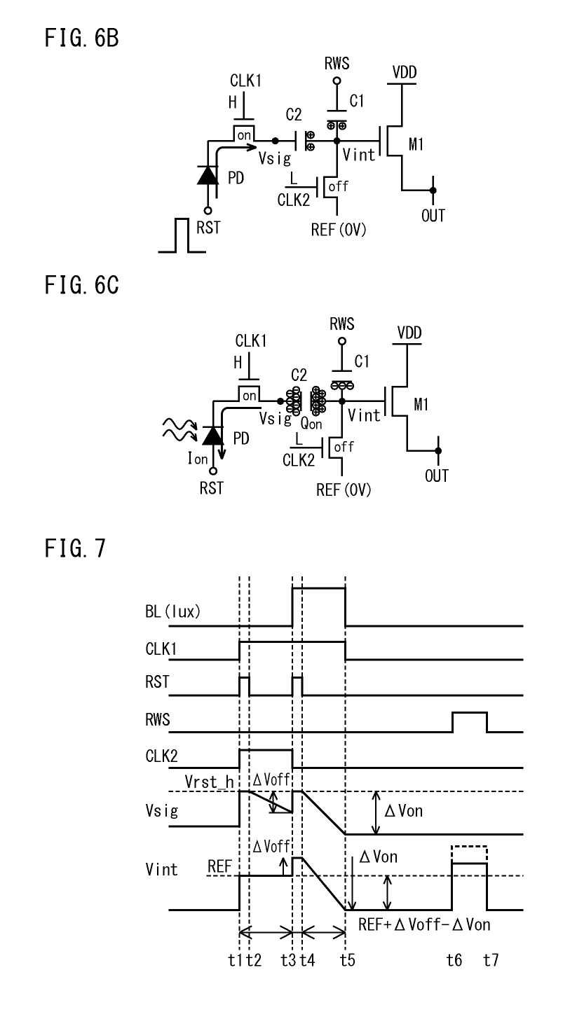

FIGS. 6A to 6C show operations of the sensor pixel circuit 9a in the case where it is driven by the signals shown in FIG. 5. As shown in FIGS. 6A to 6C, the sensor pixel circuit 9a carries out (a) accumulation of OFF signals (FIG. 6A), (b) sampling of OFF signals (FIG. 6B), and (c) accumulation of ON signals (FIG. 6C) during one frame period. It should be noted that the “OFF signal” refers to a signal detected by the photodiode PD in a state in which the backlight 3 is turned off, and corresponds to a noise component of the photodiode PD. The “ON signal” refers to a signal detected by the photodiode PD in a state in which the backlight 3 is turned on, and corresponds to a sum of a signal current of the photodiode PD and the noise component thereof.

FIG. 7 is a signal waveform diagram of the sensor pixel circuit 9a in the case where it is driven by the signals shown in FIG. 5. In FIG. 7, “BL” indicates illuminance of the backlight 3, and “Ving” indicates a potential of the node Vsig (drain potential of the transistor T1). The period from the time t1 to the time t2 is a reset period, and the period from the time t2 to the time t3 is an accumulation period during the backlight-off period of the backlight 3 (OFF signal accumulation period). The period from the time t3 to the time t4 is a reset period, and the period from the time t4 to the time t5 is an accumulation period during the backlight-on period of the backlight 3 (ON signal accumulation period). The period from the time t5 to the time t6 is a retention period for retention of a difference signal as a difference between the ON signal and the OFF signal. The period from the time t6 to the time t7 is a readout period for reading out the difference signal.

During the reset period from t1 to t2, the clock signals CLK1 and CLK2 rise to a high level, the readout signal RWS falls to a low level, and the reset signal RST rises to a high level for resetting. Here, the transistors T1 and T2 are turned on. Therefore, an electric current (forward current of the photodiode PD) flows from the reset line RST via the photodiode PD and the transistor T1 to the node Vsig, whereby the potential of the node Vsig is reset to a predetermined level.

During the accumulation period from t2 to t3, the clock signals CLK1 and CLK2 are at the high level, and the reset signal RST and the readout signal RWS are at low levels. Here, the transistors T1 and T2 are turned on. When light is incident on the photodiode PD in this state, an electric current flows from the node Vsig via the transistor T1 and the photodiode PD to the reset line RST, and charges are drawn out of the node Vsig (FIG. 6A). Therefore, the potential Vsig falls by a degree according to an amount of light incident during a period while the clock signal CLK is at the high level, whereby charges Qoff are accumulated in the capacitor C2. It should be noted that here, as the backlight 3 is in an OFF state, the charges Qoff (OFF signal) accumulated in the capacitor C2 during the period from t2 to t3 correspond to the noise component of the photodiode PD. It should be noted that the period from t1 to t3 in FIG. 7 corresponds to the period from ta to tb in FIG. 5.

Here, the node Vsig has the following potential:

Vsig=Vrst_{—}h−Qoff/C2 (1)

Vrst_h represents a high-level potential of the reset signal RST, and Qoff represents a value of an integral of the OFF current (Ioff) flowing through the photodiode PD. It should be noted that here the potential of the accumulation node Vint is equal to the reference voltage Vref supplied from the power source line REF.

During the reset period from t3 to t4, the clock signal CLK1 is at a high level, the reset signal RST rises to a high level, and the clock signal CLK2 falls to a low level. The readout signal RWS remains at a low level. This causes the transistor T1 to be turned on, and the transistors T2 and M1 to be turned off. As the transistor T1 assumes an ON state, and the reset signal RST is at a high level, the node Vsig has a potential equal to the high level potential of the reset signal RST (FIG. 6B). Further, the charges Qoff accumulated in the capacitor C2 move to the accumulation node Vint, and are accumulated in the capacitors C1 and C2.

Here, the accumulation node Vint has the following potential:

Vint=Vref+Qoff/(C1+C2) (2)

During the ON signal accumulation period from t4 to t5, the clock signal CLK1 is at the high level. The reset signal RST, the readout signal RWS, and the clock signal CLK2 are at the low levels. It should be noted that here the backlight 3 is in the ON state during the period from t3 to t5. In other words, the period from t3 to t5 in FIG. 7 corresponds to the period from tb to tc in FIG. 5. When light is incident on the photodiode PD during the period from t4 to t5, an ON current (a photoelectric current of the photodiode PD) flows from the node Vsig via the transistor T1 and the photodiode PD to the reset line RST, and charges are drawn out of the node Vsig (FIG. 6C). This causes the potential Vsig to fall by a degree according to an amount of light incident during a period while the clock signal CLK1 is at the high level, whereby charges Qon are accumulated in the capacitor C2. It should be noted that here, as the backlight 3 is in the ON state, the charges Qon (ON signal) accumulated in the capacitor C2 during the period from t4 to t5 correspond to a sum of the photoelectric current component of the photodiode PD and the noise component of the photodiode PD.

Here, the node Vsig has the following potential:

Vsig=Vrst_{—}h−Qon/(C1//C2) (3)

Qon represents a value of an integral of the ON current (Ion) of the photodiode PD. C1//C2 represents a synthetic capacitance in the case where the capacitors C1 and C2 are connected in series. The accumulation node Vint has the following potential:

Vint=Vref+Qoff/(C1+C2)−Qon/C1 (4)

As is clear from this expression, the potential of the accumulation node Vint during the ON signal accumulation period from t4 to t5 is a value corresponding to the difference between the OFF signal and the ON signal.

During the readout period from t6 to t7, the clock signals CLK1 and CLK2 and the reset signal RST are at the low levels, and the readout signal RWS rises to the high level for readout. Here, the transistors T1 and T2 are turned off. Here, the potential Vint rises by (Cl/Cpa) time an amount of rise of the potential of the readout signal RWS (where Cpa represents a value of a capacitance of the sensor pixel circuit 9a as a whole). The transistor M1 forms a source follower amplifying circuit that has, as its load, a transistor (not shown) included in the source driver circuit 6, and drives the output line OUT according to the potential Vint.

As described above, according to the present embodiment, a difference between the OFF signal obtained during the period in the backlight-off period of the backlight 3 and the ON signal obtained during the backlight-on period of the backlight 3 is determined by one sensor pixel circuit 9a. Therefore, as the value of the difference between the OFF signal and the ON signal is accumulated in the sensor pixel circuit 9a, it is not likely that output saturation of the photodiode would occur. This makes it possible to realize a display device having a high-precision input function that is not influenced by light environments, as compared with the conventional configuration in which the sensing operations are carried out separately during the backlight-on period and the backlight-off period and a difference between sensor outputs thereof is determined. Besides, since both of the OFF signal and the ON signal are determined by one photodiode provided in the sensor pixel circuit 9a, the possibility that noises due to photodiode characteristic variations could be contained can be eliminated, as compared with the configuration in which the OFF signal and the ON signal are obtained by individual photodiodes, respectively. Consequently, a high-precision sensor output having a wide dynamic range can be obtained.

### Embodiment 2

Hereinafter, Embodiment 2 of the display device of the present invention is explained. The members having the same functions as those of Embodiment 1 are denoted by the same reference numerals as those in Embodiment 1, and explanations of the same are omitted.

In Embodiment 2, the specific configuration of the sensor pixel circuit 9 is the same as that of the sensor pixel circuit 9a of Embodiment 1 described above, but the method for driving the sensor pixel circuit 9 is different from that for the sensor pixel circuit 9a of Embodiment 1.

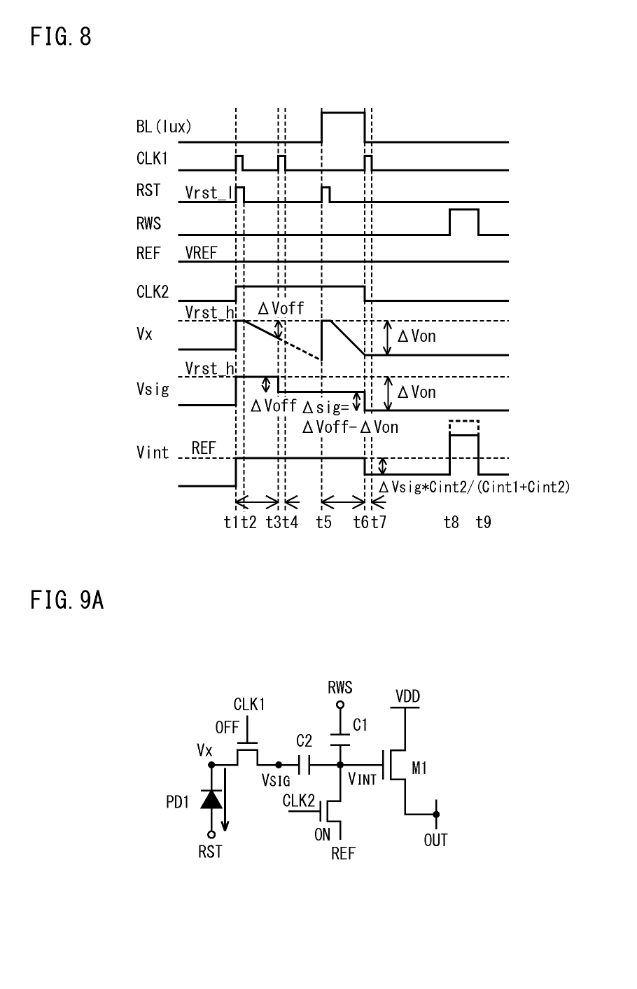

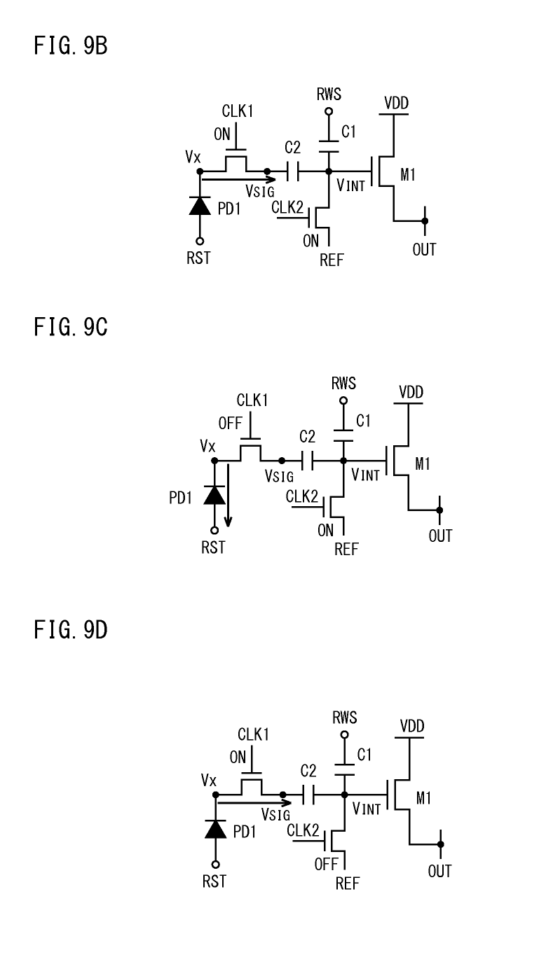

FIG. 8 is a waveform diagram of signals applied to the sensor pixel circuit 9a in Embodiment 2. FIGS. 9A to 9D show operations of the sensor pixel circuit 9a in the case where the sensor pixel circuit 9a is driven by the signals shown in FIG. 8.

As shown in FIG. 8, in Embodiment 2, the clock signal CLK1 rises to the high level three times during one frame period, and the clock signal CLK2 rises to the high level once during one frame period. Besides, in Embodiment 2, the reset signal RST rises to the high level twice during one frame period.

As shown in FIGS. 9A to 9D, the sensor pixel circuit 9a carries out (a) accumulation of OFF signals (FIG. 9A), (b) sampling of OFF signals (FIG. 9B), (c) accumulation of ON signals (FIG. 9C), and (d) sampling of ON signals and accumulation of difference values into the accumulation node (FIG. 9D) during one frame period. It should be noted that the “OFF signal” refers to a signal detected by the photodiode PD in a backlight-off state of the backlight 3, and corresponds to a noise component of the photodiode PD. The “ON signal” refers to a signal detected by the photodiode PD in a backlight-on state of the backlight 3, and corresponds to a sum of a signal current and the noise component of the photodiode PD.

During the reset period from t1 to t2, the clock signals CLK1 and CLK2 rise to a high level, the readout signal RWS falls to a low level, and the reset signal RST rises to a high level for resetting. Here, the transistors T1 and T2 are in the ON state. Therefore, an electric current (forward current of the photodiode PD) flows from the reset line RST via the photodiode PD and the transistor T1 to the node Vsig, whereby the potentials of the nodes Vx and Vsig are reset to respective predetermined levels.

During the OFF signal accumulation period from t2 to t3, the clock signal CLK1 falls to a low level, the clock signal CLK2 is at the high level, and the reset signal RST and the readout signal RWS are at low levels. Here, the transistor T1 is in the OFF state, and the transistor T2 is in the ON state. When light is incident on the photodiode PD in this state, an electric current flows from the node Vx via the photodiode PD to the reset line RST, and charges are drawn out of the node Vx (FIG. 9A). Therefore, the potential Vx falls by a degree according to an amount of light incident during a period from t2 to t3. It should be noted that here, as the backlight 3 is in the OFF state, the amount of the fall in the potential of the node Vx (ΔVoff) corresponds to the noise component of the photodiode PD.

Here, the node Vx has the following potential:

Vx=Vrst_{—}h−ΔQoff (5)

where ΔQoff=Ioff·t/Cx (6)

where t represents the duration of the accumulation period from t2 to t3; and Cx represents a parasitic capacitance of the node Vx, and satisfies:

CX=C_{PD}+C_{ITO}+C_{RWS} (7)

It should be noted that C_{PD} represents a parasitic capacitance between the photodiode PD and the node Vx; C_{ITO} represents a parasitic capacitance between the pixel electrode film and the node Vx; and CRWS represents a parasitic capacitance between the readout line RWS and the node Vx. The node Vx has a better sensitivity characteristic as the value of Cx is smaller. Besides, in order to improve charge sharing, C_{X}>C2 is satisfied preferably. In order to improve a sensitivity characteristic of Vint, C2>C1 is satisfied preferably.

During the OFF signal sampling period from t3 to t4, the clock signals CLK1 and CLK2 are at the high levels, and the reset signal RST and the readout signal RWS are at the low levels. The rise of the clock signal CLK1 to the high level causes the transistor T1 to be turned on. This causes charges at the node Vx to be transferred to the node Vsig, and to be accumulated in the capacitor C2 (FIG. 9B). Here, the node Vsig has the following potential:

Vsig=Vrst_{—}h−ΔVoff·Cx/(Cx+C2) (8)

During the ON signal accumulation period from t5 to t6, the clock signal CLK1 is at the low level. The reset signal RST once rises to the high level at the time t5, and thereafter is switched to the low level. The readout signal RWS is at the low level. The clock signal CLK2 is at the high level. It should be noted that the backlight 3 is in the ON state during the period from t5 to t6. When light is incident on the photodiode PD during the period from t5 to t6, an ON current (a signal current of the photodiode PD) flows from the node Vx via the photodiode PD to the reset line RST, and charges are drawn out of the node Vx (FIG. 9C). This causes the potential Vsig to fall by a degree according to an amount of light incident on the photodiode PD during the period from t5 to t6, whereby charges Qon are accumulated in the capacitor C2. It should be noted that here, as the backlight 3 is in the ON state, the charges Qon (ON signal) accumulated in the capacitor C2 during the period from t5 to t6 correspond to a sum of the signal current component of the photodiode PD and the noise component of the photodiode PD.

Here, the node Vx has the following potential:

Vx=Vrst_{—}h−ΔVon (9)

ΔVon=Ion·t/Cx (10)

During the ON signal sampling period from t6 to t7, the clock signal CLK1 is at the high level, and the reset signal RST, the readout signal RWS, and the clock signal CLK2 are at the low level. The backlight 3 is in the OFF state. The rise of the clock signal CLK1 to the high level causes the transistor T1 to be turned on. This causes charges (ON signal) at the node Vx accumulated during the period from t5 to t6 to be transferred to the node Vsig (FIG. 9D). Here, the node Vsig has the following potential:

Vsig=Vrst_{—}h−ΔVon·Cx/(Cx+C2)−ΔVoff·{Cx/(Cx+C2)}·{C2/(Cx+C2)} (11)

It should be noted that as the clock signal CLK2 is at the low level, the transistor T2 is in the OFF state. Therefore, from the above expressions (11) and (8), the value of the difference ΔVsig between the ON signal and the OFF signal at the node Vsig is as follows:

ΔVsig={Cx/(Cx+C2)}{ΔVon−ΔVoff+ΔVoff·C2/(Cx+C2))} (12)

Further, the node Vint has the following potential:

Vint=Vref−ΔVsig·C2(C1+C2+Cy) (13)

where Cy represents a parasitic capacitance other than C1 and C2 at the accumulation node Vint.

During the readout period from t8 to t9, the clock signals CLK1 and CLK2 as well as the reset signal RST are at the low levels, and the readout signal RWS is at the high level for readout. As is the case with Embodiment 1, this causes the transistor M1 to form a source follower amplifying circuit that has, as its load, a transistor (not shown) included in the source driver circuit 6, and drives the output line OUT according to the potential of the accumulation node Vint.

### Embodiment 3

Hereinafter, Embodiment 3 of the present invention is explained.

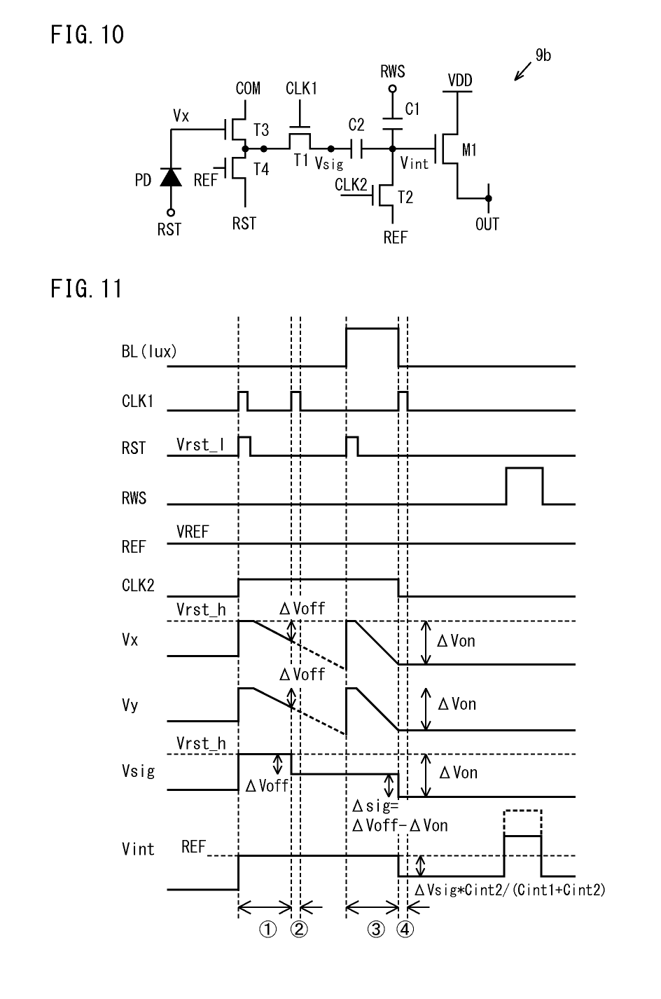

FIG. 10 is a circuit diagram showing a configuration of a sensor pixel circuit 9b as a specific example of the sensor pixel circuit 9 according to Embodiment 3. As shown in FIG. 10, the sensor pixel circuit 9b according to the present embodiment includes transistors T3 and T4 between the cathode of the photodiode PD and the transistor T1. The gate of the transistor T3 is connected to the cathode of the photodiode PD. The source of the transistor T3 is connected to a constant voltage source COM. The drain of the transistor T3 is connected to the source of the transistor T4. The gate of the transistor T4 is connected to the reset line RST. The drain of the transistor T4 is connected to the reset line RST. The transistors T3 and T4 form a unity gain amplifier.

FIG. 11 is a waveform diagram showing an operation of the sensor pixel circuit 9b shown in FIG. 10. As shown in FIG. 11, the waveforms of the clock signals CLK1 and CLK2, the reset signal RST, and the readout signal RWS supplied to the sensor pixel circuit 9b in the display device according to the present embodiment are identical to those in Embodiment 2 (see FIG. 8).

The sensor pixel circuit 9b according to the present embodiment, as being provided with the transistors T3 and T4, makes it possible to prevent charge loss from occurring when charges are transferred from the node Vx to the node Vsig during the period from t3 to t4 and during the period from t6 to t7. Thus, the sensor pixel circuit 9 having improved sensitivity characteristics can be realized.

### Embodiment 4

Hereinafter, Embodiment 4 of the present invention is explained.

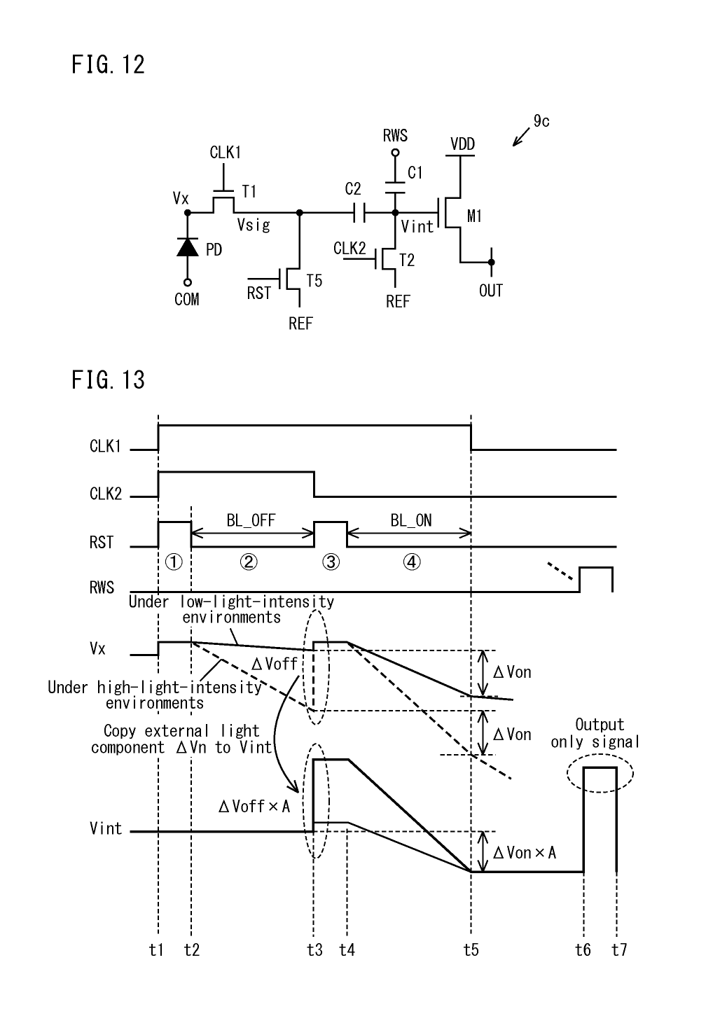

FIG. 12 is a circuit diagram showing a configuration of a sensor pixel circuit 9c as a specific example of the sensor pixel circuit 9 according to Embodiment 4. As shown in FIG. 12, the sensor pixel circuit 9c according to the present embodiment is different from the sensor pixel circuit 9a according to Embodiment 1 regarding the point that the anode of the photodiode PD is connected to, not the reset line RST, but the constant voltage source COM. Further, the sensor pixel circuit 9c is different from the sensor pixel circuit 9a regarding the point that the sensor pixel circuit 9c further includes a transistor T5 that is connected between the drain of the transistor T1 and the capacitor C2. The gate electrode of the transistor T5 is connected to the reset line RST. The source of the transistor T5 is connected to the power source line REF. The drain of the transistor T5 is connected to between the drain of the transistor T1 and the capacitor C2.

FIG. 13 is a waveform diagram of a signal applied to the sensor pixel circuit 9c. As shown in FIG. 13, the clock signals CLK1 and CLK2 applied to the sensor pixel circuit 9c rise to the high levels once each during one frame period. The reset signal RST rises to the high level twice during one frame period.

In FIG. 13, during the reset period from t1 to t2, the clock signals CLK1 and CLK2 as well as the reset signal RST are at the high levels. The readout signal RWS is at the low level. This causes the transistors T1 and T2 to be turned on, and causes the potential of the node Vx to be reset to the high level Vrst_h of the reset signal. Besides, the potential of the accumulation node Vint here is equal to the reference voltage Vref supplied from the power source line REF.

During the OFF signal accumulation period from t2 to t3, the clock signals CLK1 and CLK2 are maintained at the high levels, and the reset signal RST falls to the low level. The readout signal RWS is at the low level. Therefore, the transistors T1 and T2 are in the ON state. When light is incident on the photodiode PD, an electric current flows from the node Vx via the photodiode PD to the reset line RST, and charges are drawn out of the node Vx. Therefore, the potential of the node Vx falls by a degree according to an amount of light incident during a period from t2 to t3. It should be noted that here, as the backlight 3 is in the OFF state, the amount of the fall in the potential of the node Vx (ΔVoff) corresponds to a sum of a component due to external light incident on the photodiode PD and the noise component of the photodiode PD. It should be noted that regarding the potential of Vx shown in FIG. 13, the solid line indicates potential variation of the same under low-light-intensity environments, and the broken line indicates potential variation of the same under high-light-intensity environments.

Here, the node Vx and the accumulation node Vint have the following potentials:

Vx=Vrst_{—}h−ΔVoff (14)

Vint=Vref (15)

During the period from t3 to t4, the clock signal CLK1 is at the high level, and the clock signal CLK2 falls to the low level. The reset signal RST rises to the high level, and the readout signal RWS is at the low level. The fall of the clock signal CLK2 to the low level causes the transistor T2 to be turned off. This causes the potential of the accumulation node Vint to assume a floating state. The supply of the high-level voltage Vrst_h from the reset line RST in this state causes the potential of the node Vx to be reset to the reference voltage Vref. On the other hand, the potential of the accumulation node Vint rises by a voltage corresponding to the fall in the potential (ΔVoff1 during the OFF signal accumulation period. In other words, the accumulation node Vint has the following potential:

Vint=Vref +ΔVoff·A (16)

where A represents a constant determined by a capacitance ratio between the capacitor C1 and the capacitor C2.

During the ON signal accumulation period from t4 to t5, the clock signal CLK1 is at the high level, and the clock signal CLK2 is at the low level. The reset signal RST is at the low level. The readout signal RWS is at the low level. The clock signal CLK2 is at the high level. It should be noted that the backlight 3 is in the ON state during the period from t4 to t5. When light is incident on the photodiode PD during the period from t4 to t5, an ON current (a photoelectric current of the photodiode PD) flows from the node Vx via the photodiode PD to the reset line RST, and charges are drawn out of the node Vx. This causes the potential Vx to fall by a degree according to an amount of light (external light and backlight light) incident on the photodiode PD during the period from t4 to t5. It should be noted that here, as the backlight 3 is in the ON state, the amount of the fall in the potential of the node Vx (ΔVon) corresponds to a sum of a component due to the external light and the backlight light incident on the photodiode PD and the noise component of the photodiode PD.

Here, the node Vx and the accumulation node Vint have the following potentials, respectively:

$$\begin{matrix}Vx = Vref - ( Δ Voff + Δ Von ) & ( 17 ) \\ \begin{matrix}Vint = Vref + Δ Voff \cdot A - ( Δ Voff + Von ) \cdot A \\ = Vref - Δ Von \cdot A \end{matrix} & ( 18 )\end{matrix}$$

The foregoing expressions (17) and (18) indicate that in the present embodiment, at the end (the time t5) of the ON signal accumulation period from t4 to t5, the potential of the accumulation node Vint reflects the signal light (the component of the backlight light) from which the external light component and the noise component have been removed.

During the readout period from t6 to t7, the clock signals CLK1 and CLK2 are at the low levels, the reset signal RST is at the low level, and the readout signal RWS is at the high level. This causes the transistor M1 to form a source follower amplifying circuit that has, as its load, a transistor (not shown) included in the source driver circuit 6, and drives the output line OUT according to the potential of the accumulation node Vint.

As described above, according to the present embodiment, the external light and the noise component are canceled out each other in the sensor pixel circuit 9c, whereby a high-precision sensor output can be obtained.

### Embodiment 5

Hereinafter, Embodiment 5 of the present invention is explained.

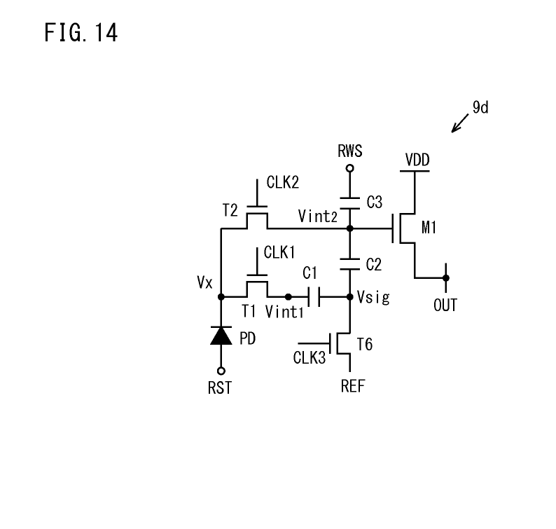

FIG. 14 is a circuit diagram showing a configuration of a sensor pixel circuit 9d as a specific example of the sensor pixel circuit 9 according to Embodiment 5. As shown in FIG. 14, in the sensor pixel circuit 9d according to Embodiment 5, both of the source of the transistors T1 and T2 are connected to the cathode of the photodiode PD. The drain of the transistor T1 is connected to one of electrodes of the capacitor C1. The other electrode of the capacitor C1 is connected to one of the electrodes of the capacitor C2. The other electrode of the capacitor C2 is connected to the drain of the transistor T2.

The sensor pixel circuit 9d further includes a capacitor C3 and a transistor T6. One of electrodes of the capacitor C3 is connected to the drain of the transistor T2, and the other electrode thereof is connected to the readout line RWS. The gate of the transistor T6 is connected to the clock signal line CLK3, the source thereof is connected to the constant power source line REF, and the drain thereof is connected to the capacitors C1 and C2. It should be noted that in the configuration shown in FIG. 14, a junction point of the transistor T1 and the capacitor C2 is denoted as an accumulation node Vint1, and a junction point of the transistor T2 and the gate of the transistor M1 is denoted as an accumulation node Vint2.

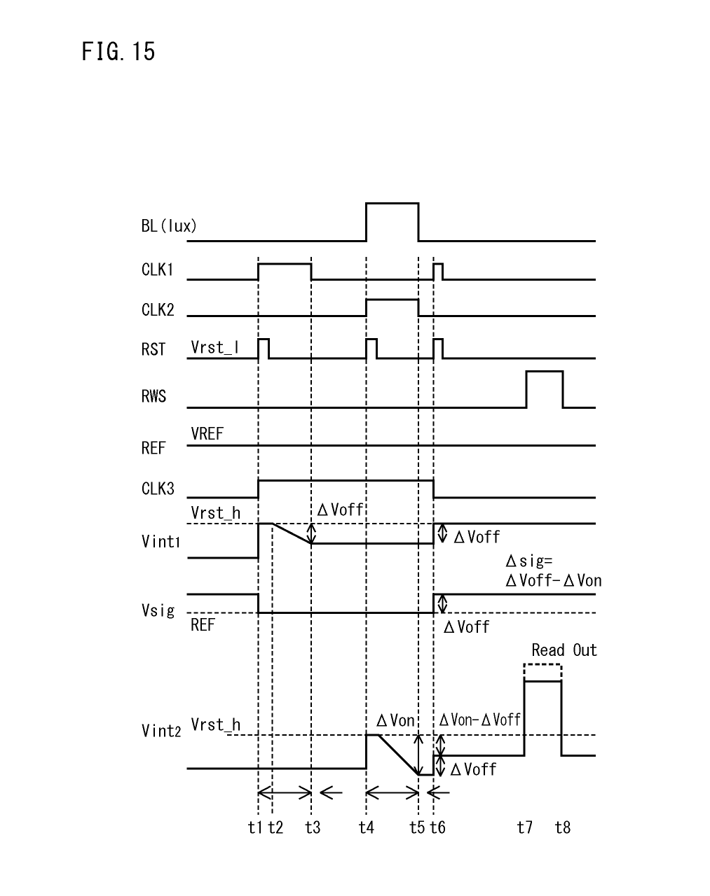

FIG. 15 is a waveform diagram of a signal applied to the sensor pixel circuit 9d. As shown in FIG. 15, the clock signal CLK1 applied to the sensor pixel circuit 9d rises to the high level twice during one frame period. The clock signal CLK2 rises to the high level once during one frame period. The reset signal RST rises to the high level three times during one frame period. The clock signal CLK3 rises to the high level once during one frame period.

In FIG. 15, during the reset period from t1 to t2, the reset signal RST rises to the high level. Since the clock signal CLK1 rises to the high level, the transistor T1 is turned on, and the potentials of the node Vx and the accumulation node Vint1 are reset to the high level potential Vrst_h of the reset signal. On the other hand, since the clock signal CLK2 is at the low level, the transistor T2 is turned off, and the potential of the accumulation node Vint2 is not rest. Since the clock signal CLK3 is at the high level, the transistor T6 is turned on, and the node Vsig has a potential of the reference voltage Vref.

During the OFF signal accumulation period from t2 to t3, the clock signal CLK1 is maintained at the high level, and the reset signal RST falls to the low level. The clock signal CLK2 is at the low level. The readout signal RWS is at the low level. Therefore, the transistor T1 is in the ON state, and the transistor T2 is in the OFF state. When light is incident on the photodiode PD, an electric current flows from the node Vx via the photodiode PD to the reset line RST, and charges are drawn out of the node Vx. Therefore, the potential Vx falls by a degree according to an amount of light incident during the period from t2 to t3. It should be noted that here, as the backlight 3 is in the OFF state, the amount of the fall in the potential of the node Vx (ΔVoff) corresponds to a sum of a component due to external light incident on the photodiode PD and the noise component of the photodiode PD. It should be noted that as the transistor T1 is in the ON state and the transistor T2 is in the OFF state during the period from t2 to t3, the potential of the accumulation node Vint1 shifts in the same manner as the potential of the node Vx, whereas the potential of the accumulation node Vint2 does not vary.

During the OFF signal retention period from t3 to t4, the clock signals CLK1 and CLK2 are at the low levels, which cause the transistors T1 and T2 to assume the OFF state. Therefore, the potential of the node Vx is retained.

At the time t4, the clock signal CLK1 falls to the low level, and the clock signal CLK2 rises to the high level. This causes the transistor T1 to be turned off, and causes the transistor T2 to be turned on. Further, the reset signal RST rises to the high level, which causes the potentials of the node Vx and the accumulation node Vint2 to be reset to the high level potential Vrst_h of the reset signal. On the other hand, as the transistor T1 is in the OFF state as described above, the potential of the accumulation node Vint1 is not reset. It should be noted that as the backlight 3 is in the ON state during the period from t4 to t5, the potential Vx falls by a degree according to an amount of light incident on the photodiode PD (external light and backlight light) during the period from t4 to t5. It should be noted that here, as the backlight 3 is in the ON state, the degree of the fall in the potential of the node Vx (ΔVon) corresponds to a sum of the component due to the external light and the backlight light incident on the photodiode PD and the noise component of the photodiode PD. It should be noted that as the transistor T2 is in the ON state and the transistor T1 is in the OFF state during the period from t4 to t5, the potential of the accumulation node Vint2 shifts in the same manner as the potential of the node Vx, whereas the potential of the accumulation node Vint1 does not vary.

During the ON signal retention period from t5 to t6, the clock signals CLK1 and CLK2 are at the low level, and the reset signal is at the low level. The backlight 3 is in the OFF state. The clock signal CLK3 is maintained at the high level.

Next, the clock signal CLK1 rises to the high level and the reset signal RST rises to the high level at the time t6, which causes the potential of the accumulation node Vint1 to rise by a voltage corresponding to ΔVoff. Along with this, the potential of the node Vsig also rises by a voltage corresponding to ΔVoff. Further, the potential of the accumulation node Vint2 also rises by a voltage corresponding to ΔVoff. Thus, as shown in FIG. 15, the accumulation node at the time t6 has the following potential:

Vint2=Vrst_{—}h−(ΔVon−ΔVoff) (19)

This shows that the potential of the accumulation node Vint2 at the time t6 reflects the signal light (the component of the backlight light) from which the external light component and the noise component have been removed.

During the readout period from t7 to t8, the clock signals CLK1 and CLK2 are at the low levels, the reset signal RST is at the low level, and the readout signal RWS is at the high level. This causes the transistor M1 to form a source follower amplifying circuit that has, as its load, a transistor (not shown) included in the source driver circuit 6, and drives the output line OUT according to the potential of the accumulation node Vint2.

As described above, according to the present embodiment, the external light and the noise component are canceled out each other in the sensor pixel circuit 9, whereby a high-precision sensor output can be obtained.

### Embodiment 6

Hereinafter, Embodiment 6 of the present invention is explained.

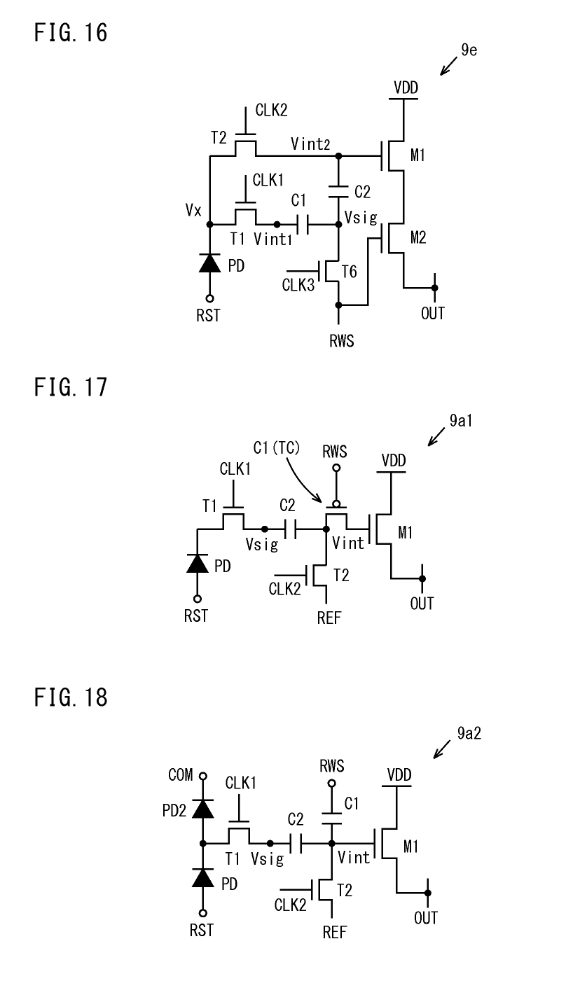

FIG. 16 is a circuit diagram showing a configuration of a sensor pixel circuit 9e as a specific example of the sensor pixel circuit 9 according to Embodiment 6. As shown in FIG. 16, the sensor pixel circuit 9e according to Embodiment 6 is different from the sensor pixel circuit 9e according to Embodiment 5 regarding the point that the capacitor C3 is omitted and the point that the readout signal line RWS is connected to the source of the transistor T6. Further, the sensor pixel circuit 9e further includes a transistor M2 connected in series with the transistor M1. The gate of the transistor M2 is connected to the source of the transistor T6.

The sensor pixel circuit 9e according to this configuration is driven also by the signal shown in FIG. 15 according to Embodiment 5, and operates in the same manner as that of the sensor pixel circuit 9d according to Embodiment 5.

As described above, according to the present embodiment, the external light and the noise component are canceled out each other in the sensor pixel circuit 9, whereby a high-precision sensor output can be obtained.

### MODIFICATION EXAMPLE

So far Embodiments 1 to 6 have been explained. It is also possible to further modify the sensor pixel circuits 9 according to these embodiments. The following explains principal modification examples.

### Modification Example 1 of Embodiment 1

FIG. 17 is a circuit diagram showing a configuration of a sensor pixel circuit 9a1 as one modification example of the sensor pixel circuit 9a according to Embodiment 1. As shown in FIG. 17, in the sensor pixel circuit 9a1, the capacitor C1 is formed with a transistor TC that is a P-type TFT. The drain of the transistor TC is connected to the capacitor C2, the source thereof is connected to the gate of the transistor M1, and the gate thereof is connected to the readout line RWS. The transistor TC thus connected causes the potential of the accumulation node Vint to vary significantly when a high level for readout is applied to the readout line RWS, as compared with the sensor pixel circuit 9a. Therefore, a difference between the potential of the accumulation node Vint when high-intensity light is incident and the potential of the accumulation node Vint when low-intensity light is incident is amplified, whereby the sensitivity of the sensor pixel circuit can be improved.

### Modification Example 2 of Embodiment 1

FIG. 18 is a circuit diagram showing a configuration of a sensor pixel circuit 9a2 as one modification example of the sensor pixel circuit 9a according to Embodiment 1. The sensor pixel circuit 9a2 shown in FIG. 18 has a configuration obtained by adding another photodiode PD2 to the sensor pixel circuit 9a. It should be noted that the photodiode PD2 is shielded so that light should not be incident thereon, and functions as a reference optical sensor. The anode of the photodiode PD2 is connected to the cathode of the photodiode PD, and the source of the transistor T1. A constant voltage COM is applied to the cathode of the photodiode PD2. The constant voltage COM is a potential higher than the high level potential for resetting. As a dark current flows through the photodiode PD2, temperature compensation as to the photodiode can be carried out.

### Modification Example 3 of Embodiment 1

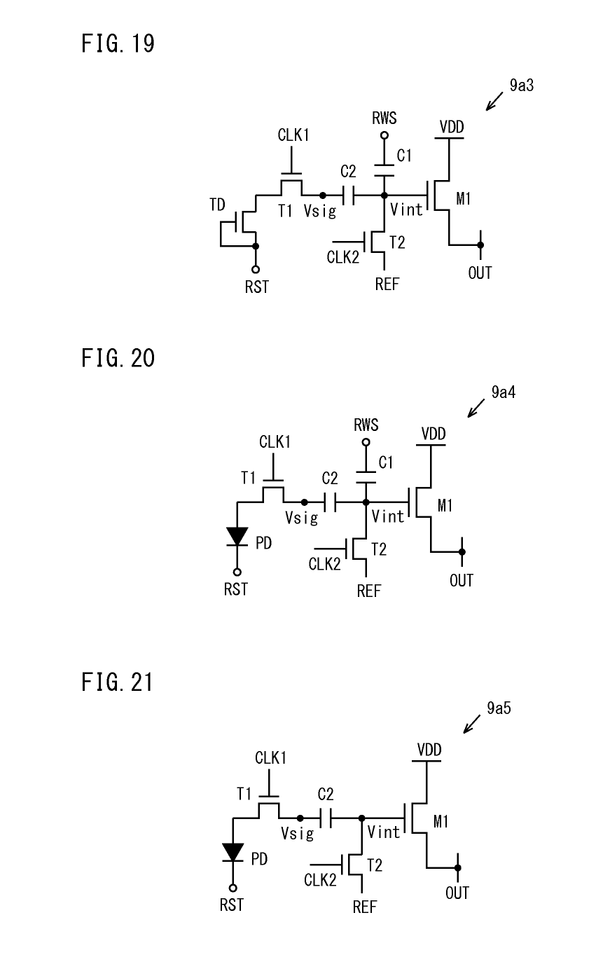

FIG. 19 is a circuit diagram showing a configuration of a sensor pixel circuit 9a3 as one modification example of the sensor pixel circuit 9a according to Embodiment 1. The sensor pixel circuit 9a3 shown in FIG. 19 has a configuration obtained by replacing the photodiode PD included in the sensor pixel circuit 9a with a phototransistor TD. This results in that all the transistors included in the sensor pixel circuit 9a3 are N-type transistors. Therefore, a sensor pixel circuit can be produced by single channel processing for producing only N-type transistors.

### Modification Example 4 of Embodiment 1

FIG. 20 is a circuit diagram showing a configuration of a sensor pixel circuit 9a4 as one modification example of the sensor pixel circuit 9a according to Embodiment 1. The sensor pixel circuit 9a4 shown in FIG. 20 has a configuration in which the photodiode PD included in the sensor pixel circuit 9a is connected reversely. To the sensor pixel circuit 9a4, a reset signal RST that is usually at a high level and upon resetting falls to a low level for resetting is supplied. The cathode of the photodiode PD is connected to the reset line RST, and the anode thereof is connected to the drain of the transistor T1. This provides a variation of the pixel circuit.

### Modification Example 5 of Embodiment 1

FIG. 21 is a circuit diagram showing a configuration of a sensor pixel circuit 9a5 as one modification example of the sensor pixel circuit 9a according to Embodiment 1. The sensor pixel circuit 9a5 shown in FIG. 21 has a configuration in which the photodiode PD included in the sensor pixel circuit 9a is connected reversely and the capacitor C1 is omitted. In the sensor pixel circuit 9a5, the readout line RWS is omitted as well. To the sensor pixel circuit 9a5, a reset signal RST that is usually at a high level and upon resetting falls to a low level for resetting is supplied, as is the case with the sensor pixel circuit 9a4 according to Modification Example 4 described above. Upon readout, however, the reset signal RST rises to a high level for readout. When the reset signal RST assumes the high level for readout, the potential of the accumulation node Vint (the gate potential of the transistor M1) rises, which causes an electric current corresponding to the potential of the accumulation node Vint to flow into the transistor M1. Thus, since the capacitor C1 is omitted in the sensor pixel circuit 9a5, it is possible to increase the aperture ratio for the area of the capacitor C1, so as to improve the sensitivity of the pixel circuit.

### Modification Example 6 of Embodiment 1

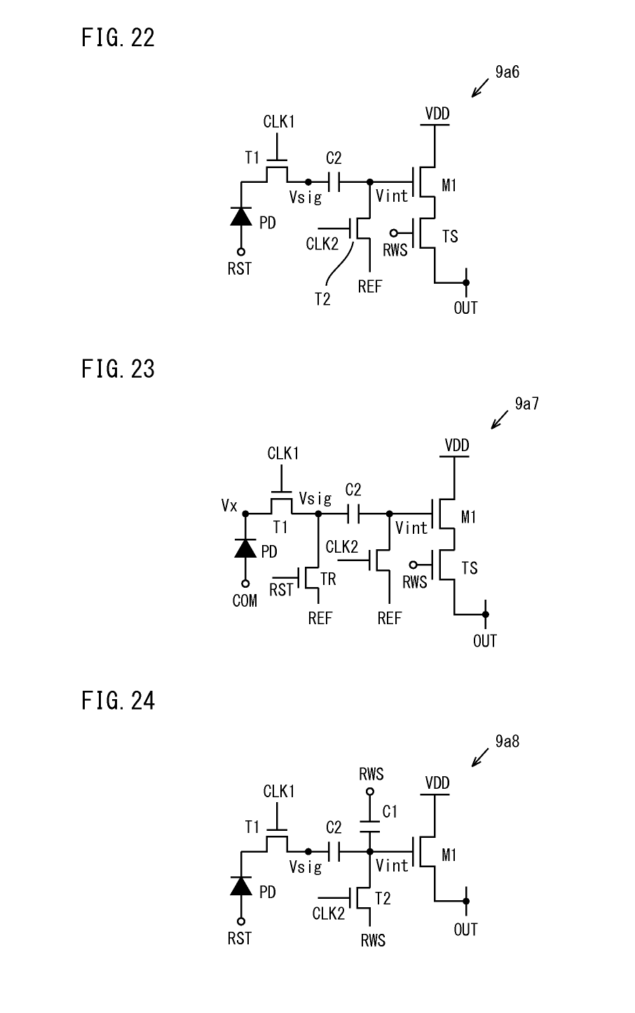

FIG. 22 is a circuit diagram showing a configuration of a sensor pixel circuit 9a6 as one modification example of the sensor pixel circuit 9a according to Embodiment 1. The sensor pixel circuit 9a6 shown in FIG. 22 has a configuration obtained by omitting the capacitor C1 and adding a transistor TS with respect to the sensor pixel circuit 9a. The transistor TS is an N-type TIT, and functions as a selection switching element. In the sensor pixel circuit 9a6, the source of the transistor M1 is connected to the drain of the transistor TS. The source of the transistor TS is connected to the output line OUT, and the gate thereof is connected to the readout line RWS. This provides a variation of the pixel circuit. Besides, since the capacitor C1 is omitted, it is possible to increase the aperture ratio for the area of the capacitor C1, so as to improve the sensitivity of the pixel circuit.

### Modification Example 7 of Embodiment 1

FIG. 23 is a circuit diagram showing a configuration of a sensor pixel circuit 9a7 as one modification example of the sensor pixel circuit 9a according to Embodiment 1. As shown in FIG. 23, the sensor pixel circuit 9a7 has a configuration obtained by adding the above-described transistors TS and TR to the sensor pixel circuit 9a. The manners of connection of the transistors TS and TR are identical to those of the sensor pixel circuits 9a6 and 9a7. This provides a variation of the pixel circuit.

### Modification Example 8 of Embodiment 1

FIG. 24 is a circuit diagram showing a configuration of a sensor pixel circuit 9a8 as one modification example of the sensor pixel circuit 9a according to Embodiment 1. As shown in FIG. 24, the sensor pixel circuit 9a8 is different from the sensor pixel circuit 9a in the point that the source of the transistor T2 is connected, not to the power source line REF for supplying the reference voltage Vref, but to the readout line RWS. This sensor pixel circuit 9a8, which does not need the power source line REF for reference voltage, has an advantage of decreasing the number of bus lines.

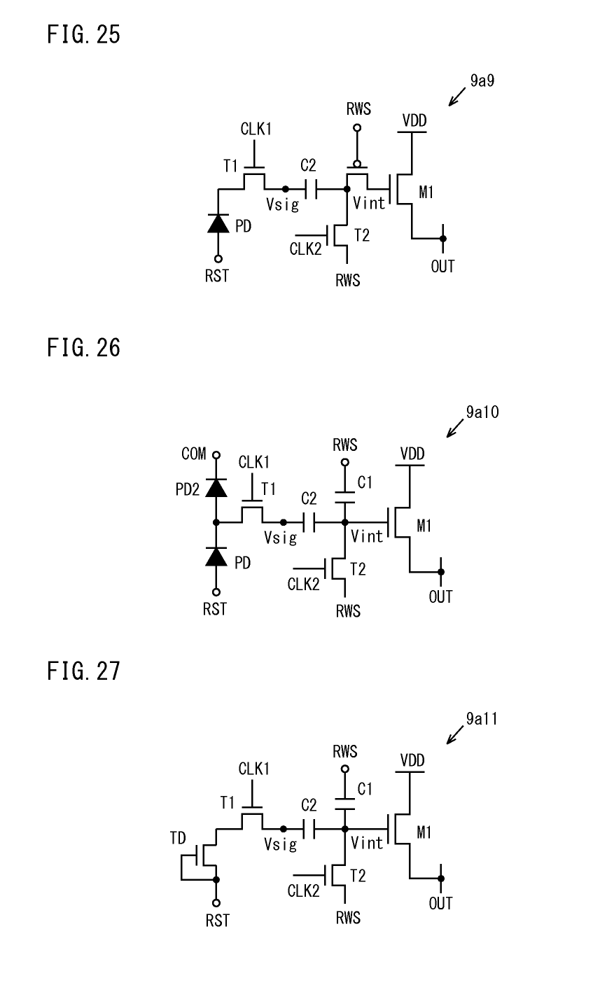

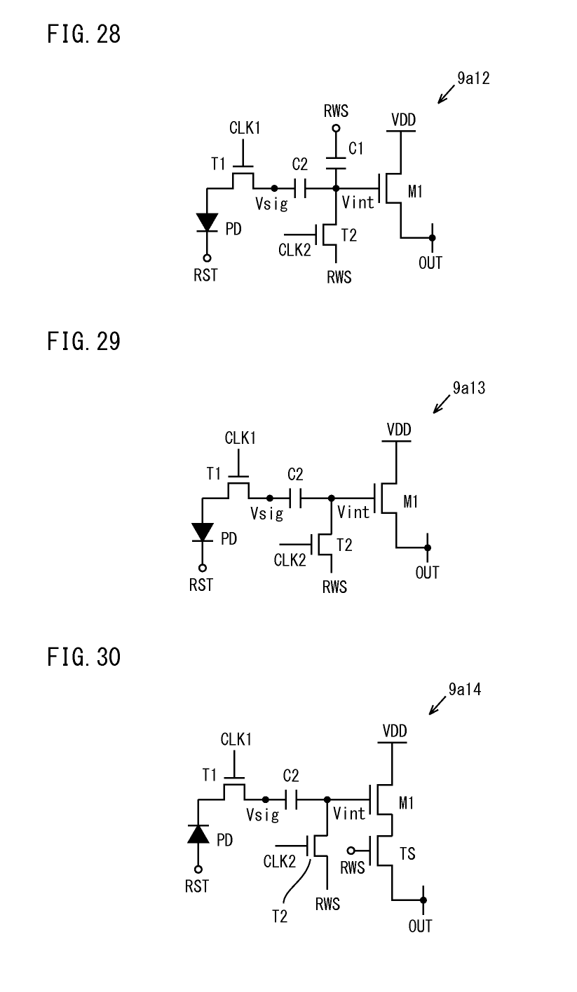

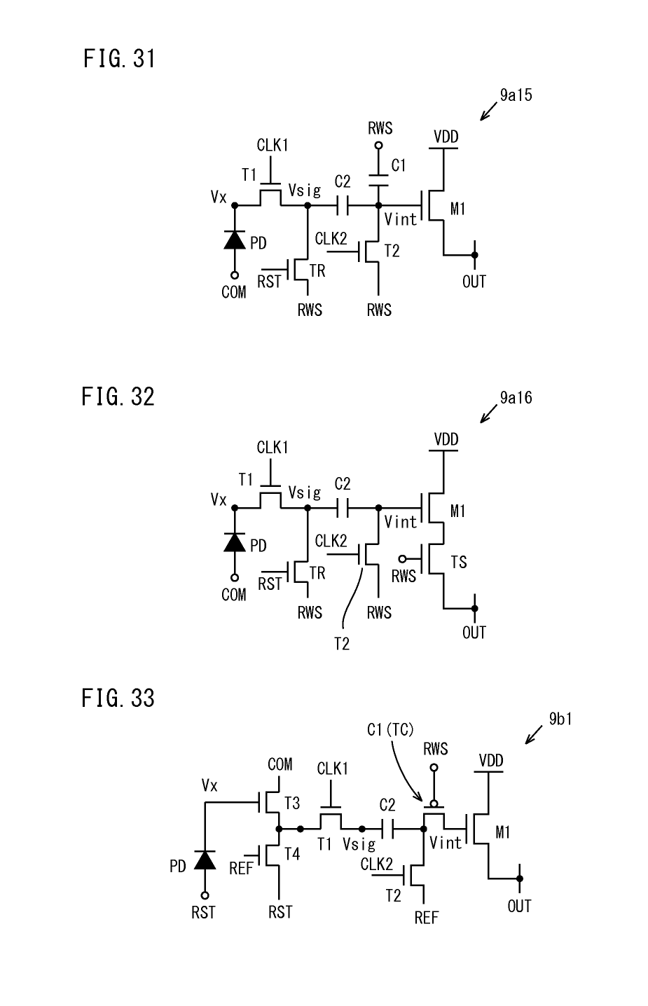

Further, as shown in FIGS. 25 to 32, variations of the sensor pixel circuit 9a include sensor pixel circuits 9a9 to 9a17 as well, which have configurations obtained by modifying the above-described sensor pixel circuits according to Modification Examples 1 to 8, respectively, by connecting the source of the transistor T2, not to the power source line REF for supplying the reference voltage Vref, but to the readout line RWS.

### Modification Example of Embodiment 2

As described above, in the display device according to Embodiment 2, the sensor pixel circuit 9 has the same specific configuration as that of the sensor pixel circuit 9a according to Embodiment 1, but the method for driving the sensor pixel circuit 9 is different from the method for driving the sensor pixel circuit 9a. In Embodiment 2, the sensor pixel circuit 9 can have the same configuration as those of the sensor pixel circuits 9a1 to 9a16 described above.

### Modification Example 1 of Embodiment 3

FIG. 33 is a circuit diagram showing a configuration of a sensor pixel circuit 9b1 as one modification example of the sensor pixel circuit 9b according to Embodiment 3. As shown in FIG. 33, in the sensor pixel circuit 9b1, the capacitor C1 is formed with a transistor TC that is a P-type TFT. The drain of the transistor TC is connected to the capacitor C2, the source thereof is connected to the gate of the transistor M1, and the gate thereof is connected to the readout line RWS. The transistor TC thus connected causes the potential of the accumulation node Vint to vary significantly when a high level for readout is applied to the readout line RWS, as compared with the sensor pixel circuit 9b. Therefore, a difference between the potential of the accumulation node Vint when high-intensity light is incident and the potential of the accumulation node Vint when low-intensity light is incident is amplified, whereby the sensitivity of the sensor pixel circuit can be improved.

### Modification Example 2 of Embodiment 3

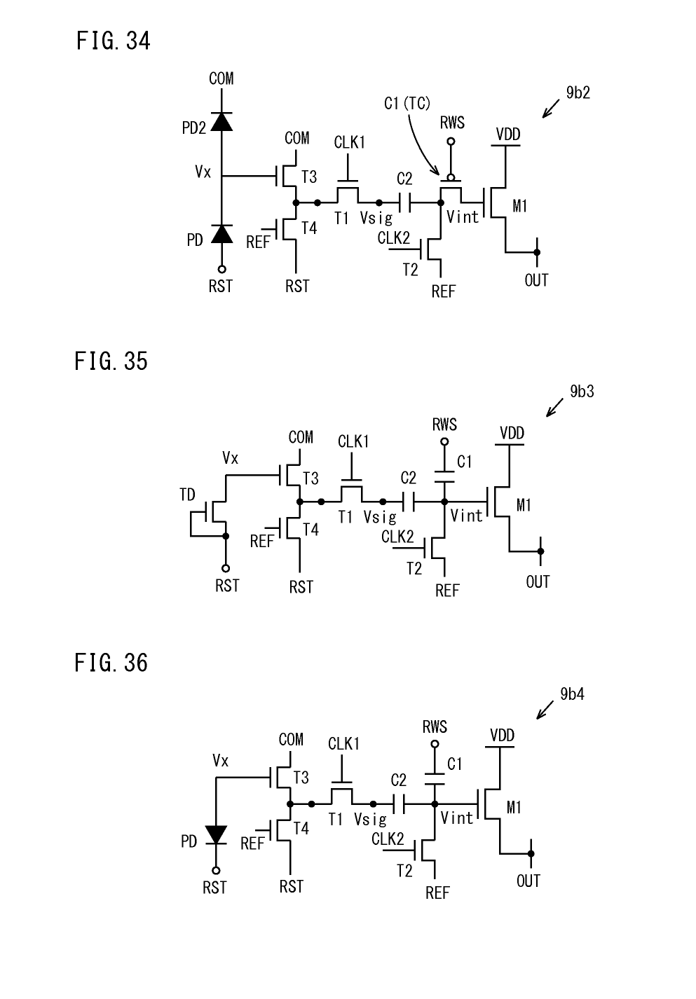

FIG. 34 is a circuit diagram showing a configuration of a sensor pixel circuit 9b2 as one modification example of the sensor pixel circuit 9b according to Embodiment 3. The sensor pixel circuit 9b2 shown in FIG. 34 has a configuration obtained by adding another photodiode PD2 to the sensor pixel circuit 9b. It should be noted that the photodiode PD2 is shielded so that light should not be incident thereon, and functions as a reference optical sensor. The anode of the photodiode PD2 is connected to the cathode of the photodiode PD, and the source of the transistor T3. A constant voltage COM is applied to the cathode of the photodiode PD2. The constant voltage COM is a potential higher than the high level potential for resetting. As a dark current flows through the photodiode PD2, temperature compensation as to the photodiode can be carried out. It should be noted that in FIG. 34, the capacitor C1 is formed with the transistor TC, but the capacitor C1 may be formed with a usual capacitor.

### Modification Example 3 of Embodiment 3

FIG. 35 is a circuit diagram showing a configuration of a sensor pixel circuit 9b3 as one modification example of the sensor pixel circuit 9b according to Embodiment 3. The sensor pixel circuit 9b3 shown in FIG. 35 has a configuration obtained by replacing the photodiode PD included in the sensor pixel circuit 9b with a phototransistor TD. This results in that all the transistors included in the sensor pixel circuit 9a3 are N-type transistors. Therefore, a sensor pixel circuit can be produced by single channel processing for producing only N-type transistors.

### Modification Example 4 of Embodiment 3

FIG. 36 is a circuit diagram showing a configuration of a sensor pixel circuit 9b4 as one modification example of the sensor pixel circuit 9b according to Embodiment 3. The sensor pixel circuit 9b4 shown in FIG. 36 has a configuration in which the photodiode PD included in the sensor pixel circuit 9b is connected reversely. To the sensor pixel circuit 9b4, a reset signal RST that is usually at a high level and upon resetting falls to a low level for resetting is supplied. The cathode of the photodiode PD is connected to the reset line RST, and the anode thereof is connected to the drain of the transistor T1. This provides a variation of the pixel circuit.

### Modification Example 5 of Embodiment 3

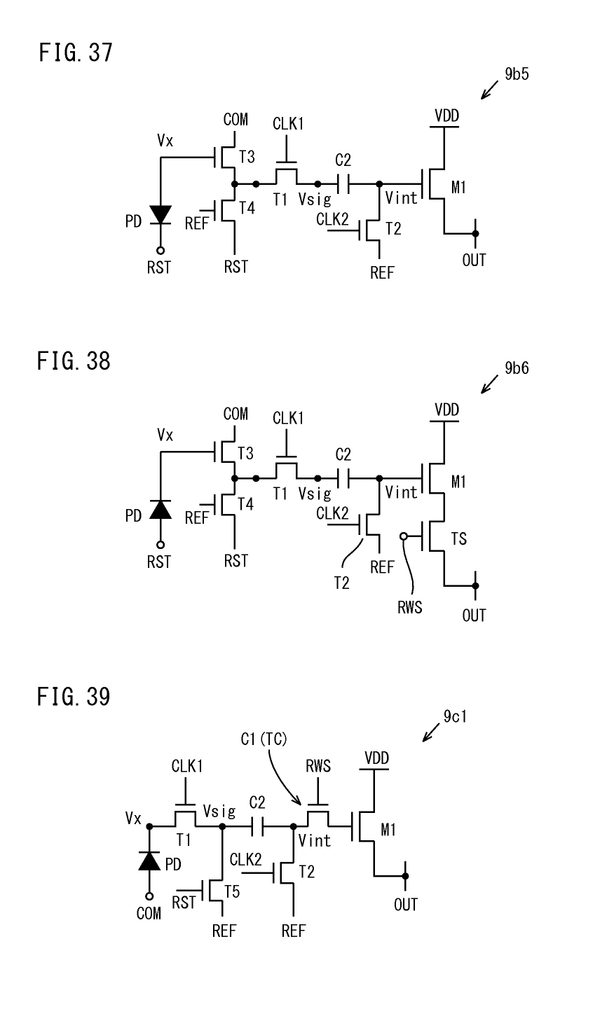

FIG. 37 is a circuit diagram showing a configuration of a sensor pixel circuit 9b5 as one modification example of the sensor pixel circuit 9b according to Embodiment 3. The sensor pixel circuit 9b5 shown in FIG. 37 has a configuration in which the photodiode PD included in the sensor pixel circuit 9b is connected reversely and the capacitor C1 is omitted. In the sensor pixel circuit 9b5, the readout line RWS is omitted as well. To the sensor pixel circuit 9b5, a reset signal RST that is usually at a high level and upon resetting falls to a low level for resetting is supplied, as is the case with the sensor pixel circuit 9b4 according to Modification Example 4 described above. Upon readout, however, the reset signal RST rises to a high level for readout. When the reset signal RST assumes the high level for readout, the potential of the accumulation node Vint (the gate potential of the transistor M1) rises, which causes an electric current corresponding to the potential of the accumulation node Vint to flow into the transistor M1. Thus, since the capacitor C1 is omitted in the sensor pixel circuit 9b5, it is possible to increase the aperture ratio for the area of the capacitor C1, so as to improve the sensitivity of the pixel circuit.

### Modification Example 6 of Embodiment 3

FIG. 38 is a circuit diagram showing a configuration of a sensor pixel circuit 9b6 as one modification example of the sensor pixel circuit 9b according to Embodiment 3. The sensor pixel circuit 9b6 shown in FIG. 38 has a configuration obtained by omitting the capacitor C1 and adding a transistor TS with respect to the sensor pixel circuit 9b. The transistor TS is an N-type TFT, and functions as a selection switching element. In the sensor pixel circuit 9b6, the source of the transistor M1 is connected to the drain of the transistor TS. The source of the transistor TS is connected to the output line OUT, and the gate thereof is connected to the readout line RWS. This provides a variation of the pixel circuit. Besides, since the capacitor C1 is omitted, it is possible to increase the aperture ratio for the area of the capacitor C1, so as to improve the sensitivity of the pixel circuit.

### Modification Example 1 of Embodiment 4

FIG. 39 is a circuit diagram showing a configuration of a sensor pixel circuit 9c1 as one modification example of the sensor pixel circuit 9c according to Embodiment 4. As shown in FIG. 39, in the sensor pixel circuit 9c1, the capacitor C1 is formed with a transistor TC that is a P-type TFT. The drain of the transistor TC is connected to the capacitor C2, the source thereof is connected to the gate of the transistor M1, and the gate thereof is connected to the readout line RWS. The transistor TC thus connected causes the potential of the accumulation node Vint to vary significantly when a high level for readout is applied to the readout line RWS, as compared with the sensor pixel circuit 9c. Therefore, a difference between the potential of the accumulation node Vint when high-intensity light is incident and the potential of the accumulation node Vint when low-intensity light is incident is amplified, whereby the sensitivity of the sensor pixel circuit can be improved.

### Modification Example 2 of Embodiment 4

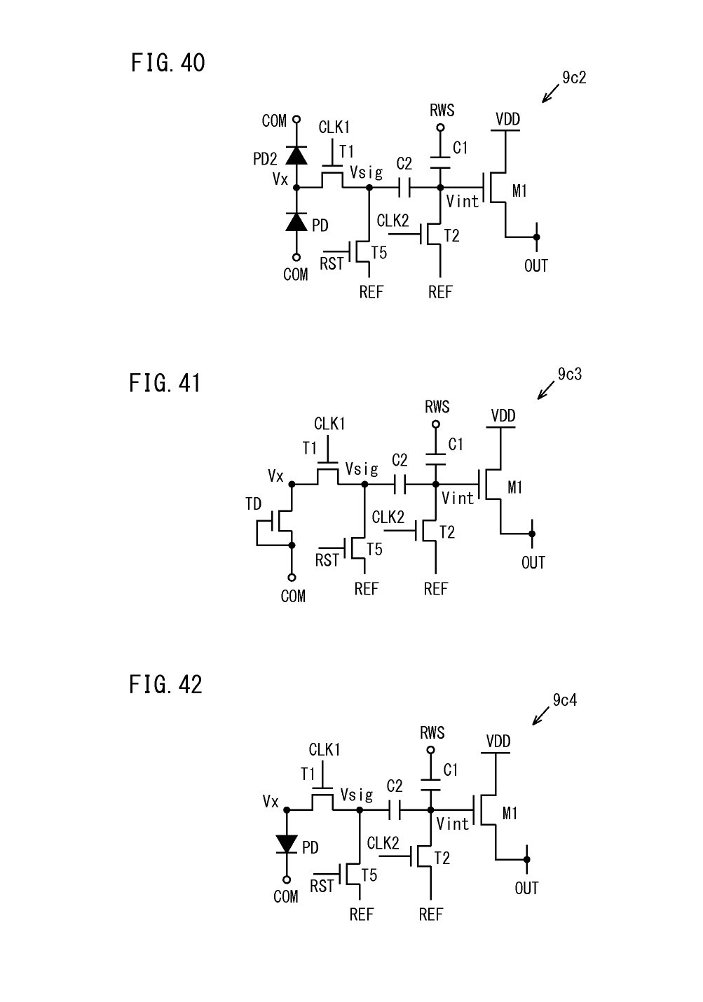

FIG. 40 is a circuit diagram showing a configuration of a sensor pixel circuit 9c2 as one modification example of the sensor pixel circuit 9c according to Embodiment 4. The sensor pixel circuit 9c2 shown in FIG. 40 has a configuration obtained by adding another photodiode PD2 to the sensor pixel circuit 9c. It should be noted that the photodiode PD2 is shielded so that light should not be incident thereon, and functions as a reference optical sensor. The anode of the photodiode PD2 is connected to the cathode of the photodiode PD, and the source of the transistor T1. A constant voltage COM is applied to the cathode of the photodiode PD2. The constant voltage COM is a potential higher than the high level potential for resetting. As a dark current flows through the photodiode PD2, temperature compensation as to the photodiode can be carried out.

### Modification Example 3 of Embodiment 4

FIG. 41 is a circuit diagram showing a configuration of a sensor pixel circuit 9c3 as one modification example of the sensor pixel circuit 9c according to Embodiment 4. The sensor pixel circuit 9c3 shown in FIG. 41 has a configuration obtained by replacing the photodiode PD included in the sensor pixel circuit 9c with a phototransistor TD. This results in that all the transistors included in the sensor pixel circuit 9c3 are N-type transistors. Therefore, a sensor pixel circuit can be produced by single channel processing for producing only N-type transistors.

### Modification Example 4 of Embodiment 4

FIG. 42 is a circuit diagram showing a configuration of a sensor pixel circuit 9c4 as one modification example of the sensor pixel circuit 9c according to Embodiment 4. The sensor pixel circuit 9c4 shown in FIG. 42 has a configuration in which the photodiode PD included in the sensor pixel circuit 9c is connected reversely. To the sensor pixel circuit 9c4, a reset signal RST that is usually at a high level and upon resetting falls to a low level for resetting is supplied. The cathode of the photodiode PD is connected to the reset line RST, and the anode thereof is connected to the drain of the transistor T1. This provides a variation of the pixel circuit.

### Modification Example 5 of Embodiment 4

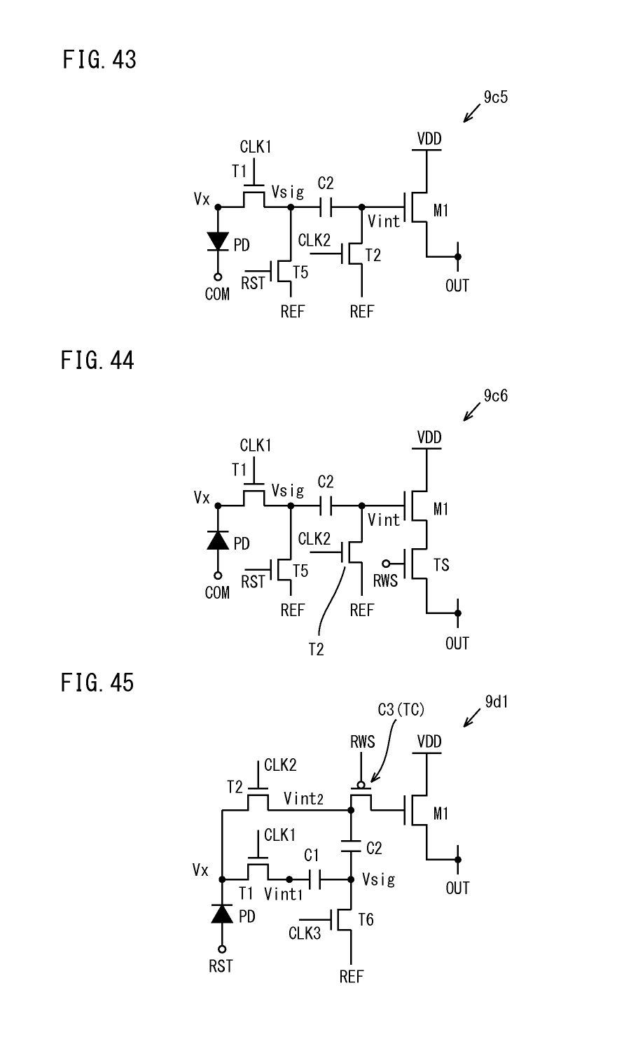

FIG. 43 is a circuit diagram showing a configuration of a sensor pixel circuit 9c5 as one modification example of the sensor pixel circuit 9c according to Embodiment 4. The sensor pixel circuit 9c5 shown in FIG. 43 has a configuration in which the photodiode PD included in the sensor pixel circuit 9c is connected reversely and the capacitor C1 is omitted. In the sensor pixel circuit 9c5, the readout line RWS is omitted as well. To the sensor pixel circuit 9c5, a reset signal RST that is usually at a high level and upon resetting falls to a low level for resetting is supplied, as is the case with the sensor pixel circuit 9c4 according to Modification Example 4 described above. Upon readout, however, the reset signal RST rises to a high level for readout. When the reset signal RST assumes the high level for readout, the potential of the accumulation node Vint (the gate potential of the transistor M1) rises, which causes an electric current corresponding to the potential of the accumulation node Vint to flow into the transistor M1. Thus, since the capacitor C1 is omitted in the sensor pixel circuit 9c5, it is possible to increase the aperture ratio for the area of the capacitor C1, so as to improve the sensitivity of the pixel circuit.

### Modification Example 6 of Embodiment 4

FIG. 44 is a circuit diagram showing a configuration of a sensor pixel circuit 9c6 as one modification example of the sensor pixel circuit 9c according to Embodiment 4. The sensor pixel circuit 9c6 shown in FIG. 44 has a configuration obtained by omitting the capacitor C1 and adding a transistor TS with respect to the sensor pixel circuit 9c. The transistor TS is an N-type TFT, and functions as a selection switching element. In the sensor pixel circuit 9c6, the source of the transistor M1 is connected to the drain of the transistor TS. The source of the transistor TS is connected to the output line OUT, and the gate thereof is connected to the readout line RWS. This provides a variation of the pixel circuit. Besides, since the capacitor C1 is omitted, it is possible to increase the aperture ratio for the area of the capacitor C1, so as to improve the sensitivity of the pixel circuit.

### Modification Example 1 of Embodiment 5

FIG. 45 is a circuit diagram showing a configuration of a sensor pixel circuit 9d1 as one modification example of the sensor pixel circuit 9d according to Embodiment 5. As shown in FIG. 45, in the sensor pixel circuit 9d1, the capacitor C1 is formed with a transistor TC that is a P-type TFT. The drain of the transistor TC is connected to the capacitor C2, the source thereof is connected to the gate of the transistor M1, and the gate thereof is connected to the readout line RWS. The transistor TC thus connected causes the potential of the accumulation node Vint to vary significantly when a high level for readout is applied to the readout line RWS, as compared with the sensor pixel circuit 9d. Therefore, a difference between the potential of the accumulation node Vint when high-intensity light is incident and the potential of the accumulation node Vint when low-intensity light is incident is amplified, whereby the sensitivity of the sensor pixel circuit can be improved.

### Modification Example 2 of Embodiment 5

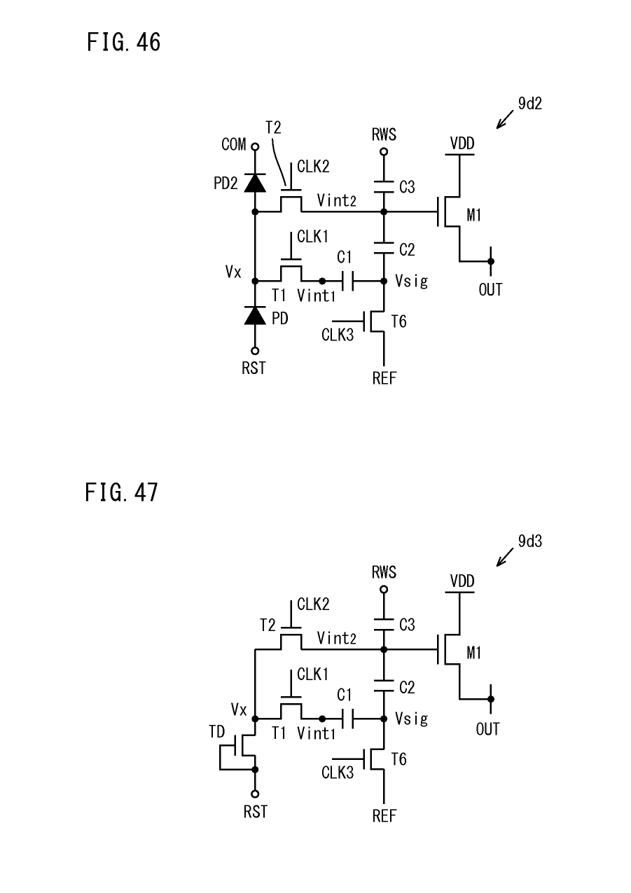

FIG. 46 is a circuit diagram showing a configuration of a sensor pixel circuit 9d2 as one modification example of the sensor pixel circuit 9d according to Embodiment 5. The sensor pixel circuit 9d2 shown in FIG. 46 has a configuration obtained by adding another photodiode PD2 to the sensor pixel circuit 9d. It should be noted that the photodiode PD2 is shielded so that light should not be incident thereon, and functions as a reference optical sensor. The anode of the photodiode PD2 is connected to the cathode of the photodiode PD, and the source of the transistor T1. A constant voltage COM is applied to the cathode of the photodiode PD2. The constant voltage COM is a potential higher than the high level potential for resetting. As a dark current flows through the photodiode PD2, temperature compensation as to the photodiode can be carried out.

### Modification Example 3 of Embodiment 5

FIG. 47 is a circuit diagram showing a configuration of a sensor pixel circuit 9d3 as one modification example of the sensor pixel circuit 9d according to Embodiment 5. The sensor pixel circuit 9d3 shown in FIG. 47 has a configuration obtained by replacing the photodiode PD included in the sensor pixel circuit 9d with a phototransistor TD. This results in that all the transistors included in the sensor pixel circuit 9d3 are N-type transistors. Therefore, a sensor pixel circuit can be produced by single channel processing for producing only N-type transistors.

### Modification Example 4 of Embodiment 5

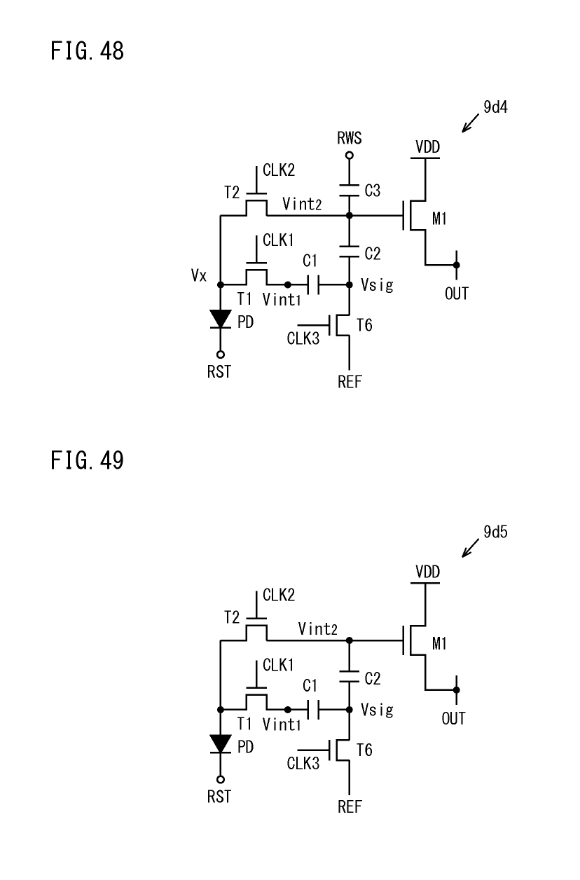

FIG. 48 is a circuit diagram showing a configuration of a sensor pixel circuit 9d4 as one modification example of the sensor pixel circuit 9d according to Embodiment 5. The sensor pixel circuit 9d4 shown in FIG. 48 has a configuration in which the photodiode PD included in the sensor pixel circuit 9d is connected reversely. To the sensor pixel circuit 9d4, a reset signal RST that is usually at a high level and upon resetting falls to a low level for resetting is supplied. The cathode of the photodiode PD is connected to the reset line RST, and the anode thereof is connected to the drain of the transistor T1. This provides a variation of the pixel circuit.

### Modification Example 5 of Embodiment 5

FIG. 49 is a circuit diagram showing a configuration of a sensor pixel circuit 9d5 as one modification example of the sensor pixel circuit 9d according to Embodiment 5. The sensor pixel circuit 9d5 shown in FIG. 49 has a configuration in which the photodiode PD included in the sensor pixel circuit 9d is connected reversely and the capacitor C1 is omitted. In the sensor pixel circuit 9d5, the readout line RWS is omitted as well. To the sensor pixel circuit 9d5, a reset signal RST that is usually at a high level and upon resetting falls to a low level for resetting is supplied, as is the case with the sensor pixel circuit 9d4 according to Modification Example 4 described above. Upon readout, however, the reset signal RST rises to a high level for readout. When the reset signal RST assumes the high level for readout, the potential of the accumulation node Vint (the gate potential of the transistor M1) rises, which causes an electric current corresponding to the potential of the accumulation node Vint to flow into the transistor M1. Thus, since the capacitor C1 is omitted in the sensor pixel circuit 9d5, it is possible to increase the aperture ratio for the area of the capacitor C1, so as to improve the sensitivity of the pixel circuit.

### Modification Example 6 of Embodiment 5

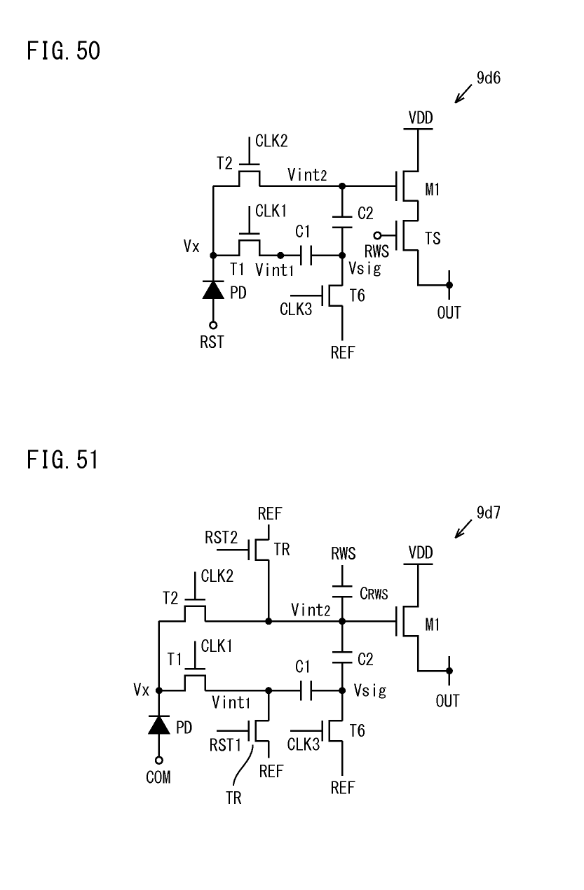

FIG. 50 is a circuit diagram showing a configuration of a sensor pixel circuit 9d6 as one modification example of the sensor pixel circuit 9d according to Embodiment 5. The sensor pixel circuit 9d6 shown in FIG. 50 has a configuration obtained by omitting the capacitor C1 and adding a transistor TS with respect to the sensor pixel circuit 9a. The transistor TS is an N-type TIT, and functions as a selection switching element. In the sensor pixel circuit 9d6, the source of the transistor M1 is connected to the drain of the transistor TS. The source of the transistor TS is connected to the output line OUT, and the gate thereof is connected to the readout line RWS. This provides a variation of the pixel circuit.

### Modification Example 7 of Embodiment 5

FIG. 51 is a circuit diagram showing a configuration of a sensor pixel circuit 9d7 as one modification example of the sensor pixel circuit 9d according to Embodiment 5. As shown in FIG. 51, the sensor pixel circuit 9d7 has a configuration obtained by adding two transistors TR1 and TR2 to the sensor pixel circuit 9d. The transistors TR1 and R2 are N-type TFTs, and function as switching elements for resetting. In the sensor pixel circuit 9d7, a reference voltage Vref is applied to the sources of the transistors TR1 and TR2. The drain of the transistor TR1 is connected to between the transistor T1 and the capacitor C1, and the gate thereof is connected to the reset line RST1. The drain of the transistor TR2 is connected to between the transistor T2 and the capacitor C2, and the gate thereof is connected to the reset line RST2. To the anode of the photodiode PD, the low level potential COM is applied. This provides a variation of the pixel circuit.

### Modification Example 8 of Embodiment 5

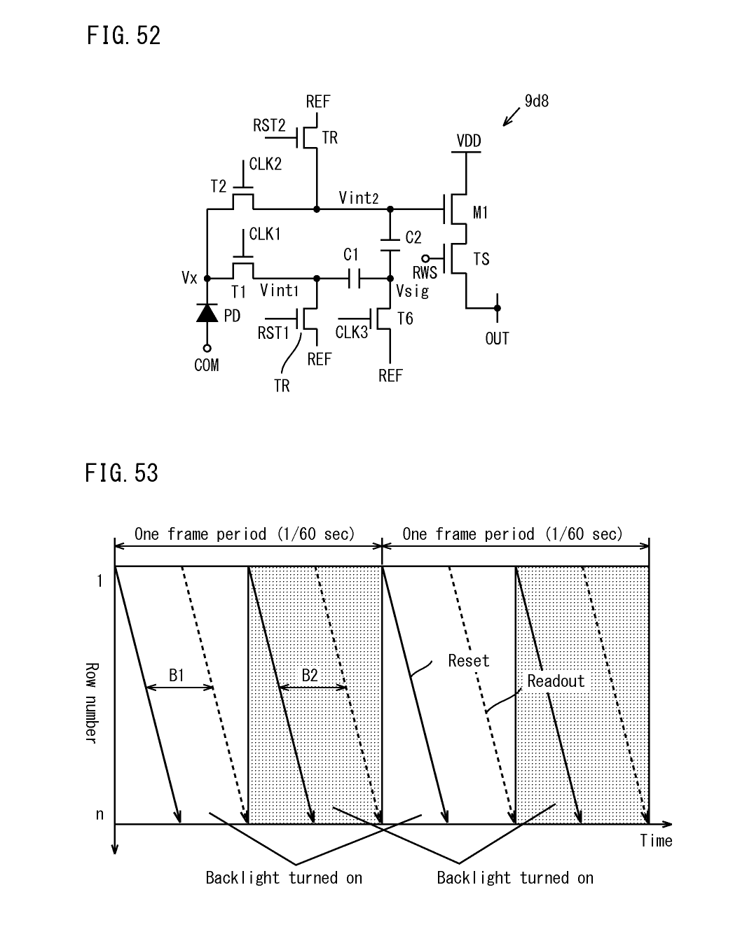

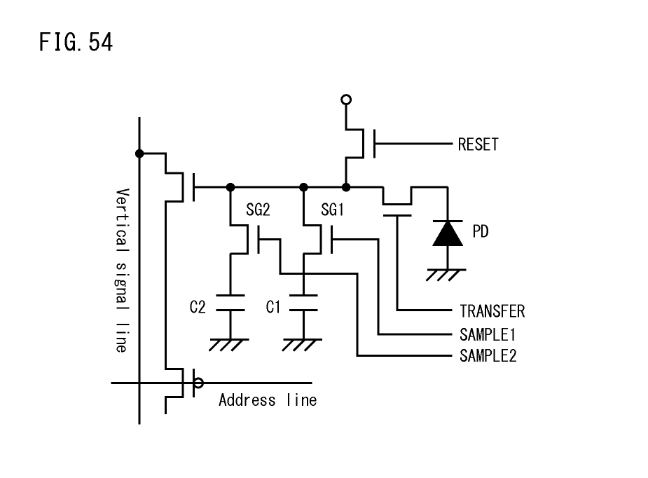

FIG. 52 is a circuit diagram showing a configuration of a sensor pixel circuit 9d8 as one modification example of the sensor pixel circuit 9d according to Embodiment 5. As shown in FIG. 52, the sensor pixel circuit 9d8 has a configuration obtained by adding the above-described transistors TS and TR to the sensor pixel circuit 9d. The manners of connection of the transistors TS and TR are identical to those of the sensor pixel circuits 9d6 and 9d7. This provides a variation of the pixel circuit.

### OTHER MODIFICATION EXAMPLES

In each of the above-described embodiments, the driving method of obtaining an OFF signal first, and then obtaining an ON signal, during one frame period is used. However, it is possible to use a driving method of obtaining the ON signal first, and then obtaining the OFF signal.

### INDUSTRIAL APPLICABILITY

The present invention is industrially applicable as a display device that has an optical sensor function.

1. A display device comprising:
a display panel that includes a plurality of display pixel circuits and a plurality of sensor pixel circuits in a display region;
a light source for sensors that is turned on for a predetermined period during one cyclic period; and
a driving circuit that supplies a driving signal to the sensor pixel circuits, wherein the sensor pixel circuit includes:
a light receiving element;
a first node that retains charges corresponding to an amount of light incident on the light receiving element; and
a second node that receives charges from the first node and retains the charges,
wherein under control by the driving circuit,
during one of a detection period while the light source for sensors is in an ON state and a detection period while the light source for sensors is in an OFF state, charges corresponding to an amount of light incident on the light receiving element during this detection period are accumulated in the first node,
the charges accumulated in the first node are transferred from the first node to the second node,
during the other one of the detection period while the light source for sensors is in the ON state and the detection period while the light source for sensors is in the OFF state, charges corresponding to an amount of light incident on the light receiving element during this detection period are accumulated in the first node,
and
the charges accumulated in the first node are transferred from the first node to the second node,
whereby a value of a difference between the amount of light accumulated during the detection period while the light source for sensors is in the ON state and the amount of light accumulated during the detection period while the light source for sensors is in the OFF state is determined in the second node.

2. The display device according to claim 1, wherein the sensor pixel circuit includes:
a first switching element that controls conduction/non-conduction between the light receiving element and the first node;
a first capacitor connected to the second node;
a second capacitor provided between the first switching element and the second node;
a second switching element that controls conduction/non-conduction between the second node and a reference voltage supplying line; and
a readout switching element connected to the second node.

3. The display device according to claim 1, wherein the sensor pixel circuit includes:
a first switching element that controls conduction/non-conduction between the light receiving element and the first node;
a first capacitor connected to the second node;
a second capacitor provided between the first switching element and the second node;
a second switching element that controls conduction/non-conduction between the second node and a reference voltage supplying line;
a readout switching element connected to the second node; and
an amplifier provided between the light receiving element and the first switching element.

4. The display device according to claim 1, wherein the sensor pixel circuit includes:
a first switching element that controls conduction/non-conduction between the light receiving element and the first node;
a first capacitor connected to the second node;
a second capacitor provided between the first switching element and the second node;
a second switching element that controls conduction/non-conduction between the second node and a reference voltage supplying line;
a readout switching element connected to the second node; and
a third switching element that resets the first node.

5. The display device according to claim 1, wherein the sensor pixel circuit includes:
a first switching element that controls conduction/non-conduction between the light receiving element and the first node;
a second switching element that controls conduction/non-conduction between the light receiving element and the second node;
a first capacitor connected to the second node;
a third node that receives charges from the first node and retains the same;
a second capacitor provided between the third node and the second node;
a third switching element that resets the third node; and
a readout switching element connected to the second node.

6. The display device according to claim 1, wherein the first capacitor is a P-type transistor.

7. The display device according to claim 1,
wherein the sensor pixel circuit further includes a reference light receiving element that is connected to the light receiving element in series and is shielded from light, and
one of two terminals other than a control terminal of the first switching element is connected to between the light receiving element and the reference light receiving element.

8. The display device according to claim 1, wherein the light receiving element is an N-type transistor.

9. The display device according to claim 1, further comprising a readout switching element connected to the second node, and a selection switching element that is connected to the readout switching element in series and controls conduction/non-conduction between the second node and an output line of the sensor pixel circuit.

10. A method for driving a display device that includes: a display panel that includes a plurality of display pixel circuits and a plurality of sensor pixel circuits in a display region; a light source for sensors that is turned on for a predetermined period during one cyclic period; and a driving circuit that supplies a driving signal to the sensor pixel circuits, wherein the sensor pixel circuit includes: a light receiving element; a first node that retains charges corresponding to an amount of light incident on the light receiving element; and a second node that receives charges from the first node and retains the charges,
the method comprising the steps of, under control by the driving circuit:
during one of a detection period while the light source for sensors is in an ON state and a detection period while the light source for sensors is in an OFF state, accumulating, in the first node, charges corresponding to an amount of light incident on the light receiving element during this detection period;
transferring the charges accumulated in the first node, from the first node to the second node;
during the other one of the detection period while the light source for sensors is in the ON state and the detection period while the light source for sensors is in the OFF state, accumulating, in the first node, charges corresponding to an amount of light incident on the light receiving element during this detection period,
and
transferring the charges accumulated in the first node, from the first node to the second node,
so that a value of a difference between the amount of light accumulated during the detection period while the light source for sensors is in the ON state and the amount of light accumulated during the detection period while the light source for sensors is in the OFF state is determined in the second node.
